(19) United States
(12) Patent Application Publication
(10) Pub. No.: US 2017/0308956 A1
(43) Pub. Date: Oct. 26, 2017

(54) CONTROL SYSTEM

(71) Applicant: BGC Partners, Inc., New York, NY (US)

(72) Inventors: Peter Bartko, New York, NY (US); John Capuano, New York, NY (US); Sven Mika, New York, NY (US); Thomas D. Bradshaw, New York, NY (US)

(21) Appl. No.: 15/649,218

(22) Filed: Jul. 13, 2017

Related U.S. Application Data
(63) Continuation of application No. 14/924,396, filed on Oct. 27, 2015.
Application No. 14/924,396 is a continuation of application No. 12/483,212, filed on Jun. 11, 2009, now abandoned.
Application No. 12/483,212 is a continuation-in-part of application No. 12/464,099, filed on May 11, 2009.

(51) Int. Cl. G06Q 40/04; G06Q 40/06; G06Q 30/06

(52) U.S. Cl. CPC G06Q 40/04; G06Q 30/06; G06Q 40/06

(57) ABSTRACT

Methods and systems are provided herewith for determining prices and executing trades for a plurality of users of an electronic trading system. A central processor may receive a processor a plurality of bid-offer pairs from a plurality of users. Each bid-offer pair may comprise a bid price and an offer price, e.g. for a financial transaction such as a currency exchange. A price of a trade may be determined based on one or more of the bid-offer pairs. The processor may match user orders to trade and transact a trade at the determined price. A price for the traded product may be measured at a predetermined time after the trade. A flow may be determined for a plurality of trades between two users based on the difference, for each trade, between the trade price and a subsequent price measured at a predetermined time after the trade. Afterwards, for at least one subsequent trade between the two users, the at least one corresponding price may be adjusted or otherwise determined based on the determined flow.

### RELATED APPLICATIONS

This application is a continuation of U.S. patent application Ser. No. 14/924,396 filed Oct. 27, 2015, which is a continuation of U.S. patent application Ser. No. 12/483,212 filed Jun. 11, 2009, which is a continuation-in-part of U.S. patent application Ser. No. 12/464,099, filed on May 11, 2009 by Peter Bartko et. al., entitled “APPARATUS AND METHODS FOR EXCHANGING PRODUCTS AT CALCULATED RATE,” the disclosures of which are incorporated herein by reference in their entireties.

### BRIEF DESCRIPTION OF THE FIGURES

FIG. 1 depicts a system according to at least one embodiment of the systems disclosed herein;

FIG. 2 depicts a system according to at least one embodiment of the systems disclosed herein;

FIG. 3 depicts a flow diagram according to at least one embodiment of the methods disclosed herein;

FIGS. 4-5 depict exemplary bid-offer pairs according to at least one embodiment of the methods disclosed herein;

FIGS. 6-7 depict an exemplary graph showing changes in a market price over time according to at least one embodiment of the methods disclosed herein;

FIGS. 8A-9B depict exemplary tables showing trading information that may be determined according to at least one embodiment of the methods disclosed herein;

FIGS. 10-13 depict exemplary graphs showing trading information that may be determined according to at least one embodiment of the methods disclosed herein;

FIGS. 14-25 depict exemplary interfaces for managing and communicating order information according to at least one embodiment of the invention;

FIG. 26 depicts an exemplary interface for configuring price adjustment information according to at least one embodiment of the invention; and

FIG. 27 depicts an exemplary interface for configuring a price adjustment amount according to at least one embodiment of the invention.

FIG. 28 depicts an exemplary interface for configuring price and counterparty parameters according to at least one embodiment of the invention.

### DETAILED DESCRIPTION

The following sections I-XI provide a guide to interpreting the present application.

Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

IV. Disclosed Examples and Terminology Are Not Limiting

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. §1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more of the following: microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

VII. 35 U.S.C. §112, paragraph 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

IX. Incorporation By Reference

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

XI. Other Definitions

An “exchange rate” for exchanging the currency of one country for currency of another is the ratio at which the unit of currency of one country is or may be exchanged for the unit of currency of another country. Accordingly, an “exchange rate” is a price, i.e., the price of one currency expressed in units of another currency. As used herein, the term “rate” may refer to an exchange rate. In some cases, the term “rate” may generally refer to a price, such as an exchange rate and/or a price of products other than exchange rates.

As used herein, two price ranges “overlap” if the two ranges cover at least one price (including fractional prices such as $10.25000001) in common.

As used herein, a “bid-offer pair” is a bid and an offer for the same product (e.g., a bid and offer to exchange one currency for another) that is associated with a single party or entity and is also associated with a specific time or duration. For example, a “bid-offer pair” may comprise a bid to buy 1 Euro for $1.50 and an offer to sell 1 Euro for $2.00, in which the bid and offer are received from a party (e.g., Bank ABC) at the same time (or at two times very close to one another).

As used herein, the terms “flow” and “price flow” may refer generally to a change in a market price of a product after the product is purchased or sold, e.g., in a trade between two parties in a trading system for financial products. A positive flow may refer to a change in a price (either in an upward or downward direction) that benefits a party after a transaction, such as when a product increases in price after a purchase or decreases in price after a sale. A flow measurement may be specific to a particular party to a transaction, as the counterparty may experience an equal and opposite flow (e.g., an increase in market price after a trade would benefit the buyer and harm the seller). In some embodiments, counterparties to a transaction may experience equal and opposite flow for that transaction. “Flow” and “price flow” may also refer to an aggregate flow or price flow for a plurality of trades involving one or more products. Flow and price flow typically change over time as the market price of a traded product (or products) changes. Flow may be measured in various ways, as discussed herein, e.g., by measuring the change in market price for a short period of time after the transaction.

As used herein, a “pip” may be the fourth decimal point of a number, e.g., in foreign exchange trading. For example, a pip may be a “cent of a cent” when expressed in units of U.S. dollars. For example, a pip may be a “cent of a cent” when expressed in units of U.S. dollars. For instance, if the currency pair EUR/USD is currently trading at 1.4000 and then the exchange rate changes to 1.4010, the pair would have moved by 10 pips. As an exception, in Yen pairs (GBP/JPY, EUR/JPY, USD/JPY) a pip may be the second decimal place, since a Japanese yen is much closer in size to a cent/hundredth of other major currencies. It should be understood that although various embodiments of the invention are discussed in reference to pips (e.g., the fourth decimal place), other decimal places such as the first, second, third, fifth, sixth, seventh, and eight may also be used instead of a pip.

Although various embodiments are described with respect to the exchange of currencies (e.g., foreign currencies), it should be understood by those of ordinary skill in the art that the system may be used for the pricing and exchange of any product or service.

### DETAILED DESCRIPTION OF EXEMPLARY EMBODIMENTS

According to various embodiments of the invention, a processes and apparatus is provided for selective electrical control of two or more light-generating or light-controlling display elements in accordance with a received or stored image data signal. For example, the stored image data signal may comprise an image of a user interface for configuring an adjustment to a market price of a future transaction, as further described herein. The image data may include character, graphical information or display attribute data. The image data may include, for example, information data from a peripheral input device, from the reception of a television signal, from the recognition of image data, or from the generation or creation of image data by a computer. In some embodiments, various embodiments of the invention may comprise digital data processing systems and methods for data processing for visual presentation, wherein the processing of data includes the creation or manipulation of graphic objects (e.g., artificial images), or text, for example. In some embodiments, the processing of data may comprise the creation or manipulation of financial data relating to one or more financial transactions between participants of a marketplace, e.g., to configure an adjustment to one or more past, present, or future transactions between one or more parties.

According to various embodiments of the invention, an apparatus comprising at least one processor and a memory may be configured to determine a market price and execute a trade between users. In one embodiment, a plurality of bid-offer pairs for a currency exchange between a first currency and a second currency is received from a plurality of users of an electronic trading system. The plurality of users comprises a first user and a second user. Each bid-offer pair comprises (1) a bid price comprising an estimate of a fair bid price for purchasing the first currency in units of the second currency and (2) an offer price comprising an estimate of a fair offer price for selling the first currency in units of the second currency. Each bid-offer pair defines (a) a range of prices between the offer price and the bid price and (b) a quote spread comprising the difference between the bid price and the offer price. A set of overlapping bid-offer pairs is determined from the plurality of bid-offer pairs. An exchange rate for converting the first currency into the second currency based on the set of overlapping bid-offer pairs is determined. A first plurality of orders is received from the first user and a second plurality of orders is received from the second user. Each order comprising at least one of an offer to purchase and an offer to sell one currency in exchange for another currency. The first plurality of orders from the first user are matched with the second plurality of orders from the second order. A plurality of trades is executed between the first user and the second user based on the act of matching. Each trade is executed at a current market price at the time of the trade. A change in the market price for each trade is monitored for a period of time. A market price adjustment amount is determined based on the act of monitoring. A user interface is outputted to each of the first user and the second user. The user interface comprises an indicia of the determined market price adjustment amount and an indicia for selecting a market price adjustment amount. A selection of a market price adjustment amount is received from at least one of the first user and the second user responsive to the act of outputting. The selected market price adjustment amount is associated in a database with the first user and the second user. After receiving the selection of the market price adjustment amount, a third plurality of orders is received from the first user and a fourth plurality of orders is received from the second user. Each order comprises at least one of an offer to purchase and an offer to sell one currency in exchange for another currency. At least one of the third plurality of orders from the first user is matched with at least one of the fourth plurality of orders from the second order. A plurality of trades are executed based on the act of matching the third plurality of orders with the fourth plurality of orders. Each trade is executed at an adjusted market price comprising (1) a current market price at the time of the trade adjusted by (2) the selected market price adjustment amount.

In another embodiment, an apparatus comprises at a memory and at least one processor. The memory may stores instructions which, when executed by the at least one processor, directs the at least one processor to perform various actions. A plurality of users of an electronic trading system may transmit a corresponding plurality of bid-offer pairs to the at least one processor. The plurality of users may comprise a first user and a second user. Each bid-offer pair may comprise (1) a bid price comprising an estimate of a fair bid price for purchasing a first currency in units of a second currency and (2) an offer price comprising an estimate of a fair offer price for selling the first currency in units of the second currency. The bid-offer pair may define (a) a range of prices between the offer price and the bid price and (b) a quote spread comprising the difference between the bid price and the offer price. The at least one processor may determine from the plurality of bid-offer pairs a set of overlapping bid-offer pairs. Determining a set of overlapping bid-offer pairs may comprise several actions. First, the at least one processor may determine that the bid price and the offer price of each bid-offer pair in the set of overlapping bid-offer pairs is unexpired during the time of interest. The at least one processor may determine whether any of the bid-offer pairs comprises a bid price that is lower than the offer price of the bid-offer pair. For each bid-offer pair, the at least one processor may determine that the bid-offer pair comprises a quote spread that is less than a predetermined threshold. Finally, the at least one processor may determine from the plurality of bid-offer pairs a set of qualifying bid-offer pairs. The set of qualifying bid-offer pairs may comprise each bid-offer pair of the plurality of bid-offer pairs that satisfies the following conditions. (a) The bid price of the bid-offer pair and the offer price of the bid-offer pair are both unexpired at the time of interest. (b) The bid price of the bid-offer pair is lower than the offer price of the bid-offer pair. (c) The bid-offer pair comprises a quote spread that is less than a predetermined threshold. The at least one processor may determine from the set of qualifying bid-offer pairs a set of overlapping bid-offer pairs. Each overlapping bid-offer pair may comprise a range such that (i) the number of bid-offer pairs having a range that overlaps the range of the bid-offer pair is at least half of (ii) the number of eligible bid-offer pairs minus one. Two ranges “overlap” if they both include at least one price in common. The at least one processor may determine an exchange rate for converting the first currency into the second currency based on the set of overlapping bid-offer pairs, in which the act of determining the exchange rate comprises calculating an average of the bids and offers in the set of overlapping bid-offer pairs. The exchange rate is equal to the average of the bids and offers in the set of overlapping bid-offer pairs. The at least one processor may receive from the first user a first order to purchase the first currency in exchange for the second currency. The at least one processor may receive from the second user a second order to sell the first currency in exchange for the second currency. The order to purchase and the order to sell are unexpired during the time of interest. The at least one processor may match the first order and the second order. The at least one processor may also execute a trade between the first user and the second user based on the act of matching. The at least one processor may transmit a confirmation of the executed trade to the first user and the second user.

In some embodiments, for each of the plurality of trades executed between the first user and the second user based on the act of matching the third plurality of orders with the fourth plurality of orders, each trade is executed at an adjusted market price that is more advantageous to the first user than the current market price at the time of the trade.

In some embodiments, each trade is executed at an adjusted market price comprising (1) a current market price at the time of the trade that is adjusted to the price advantage of the first user and to the price disadvantage of the second user by (2) the selected market price adjustment amount.

In some embodiments, the act of monitoring a change in the market price for each trade for a period of time comprises determining a market price for the traded item at least two times subsequent to the time of the trade, and determining a difference between (1) the transaction price for the traded item and (2) the determined market price at the at least two times subsequent to the time of the trade. In some embodiments, the act of determining a market price adjustment amount comprises determining a market price adjustment amount based at least on the difference between (1) the transaction price for the traded item and (2) the determined market price at the at least two times subsequent to the time of the trade.

In some embodiments, the act of determining a market price for the traded item at least two times subsequent to the time of the trade comprises determining a market price for the traded item at least two times subsequent to the time of the trade, in which the at least two subsequent times comprise times at one or more predetermined time intervals after the time of the transaction.

In some embodiments, the act of matching at least one of the third plurality of orders from the first user with at least one of the fourth plurality of orders from the second user comprises matching a plurality of orders from the first user with a plurality of orders from the second user.

In some embodiments, the act of determining the market price adjustment amount based on the act of monitoring comprises:

In some embodiments, a difference amount by which a market price of the financial product at a predetermined period of time after a transaction differs from the market price of the financial product is determined at the time of the transaction. A market price adjustment amount is determined based on the difference amount.

In some embodiments, each of the plurality of trades comprises an exchange of the first currency to the second currency.

In some embodiments, the plurality of trades comprise a plurality of exchanges of a plurality of currencies to a plurality of other currencies.

In some embodiments, the plurality of trades comprise a plurality of purchases and sales of a plurality of different financial products.

In some embodiments, each trade occurs at an exchange rate determined from a plurality of bid-offer pairs received from the plurality of users.

In some embodiments, after monitoring a change in the market price applicable to each of the plurality of first trades, a user interface comprising a graph showing a value versus time is output. The value is based on the monitored changes in the market prices applicable to the plurality of first trades after the time of each trade. A difference amount by which the market prices of the plurality of first trades at a predetermined period of time after each trade differs from the respective market price at the time of the transaction is determined.

In some embodiments, the act of monitoring a change in the market price applicable to each of the plurality of first trades for a period of time after the trade comprises receiving a selection of the predetermined period of time from at least one of the first user and the second user.

In some embodiments, the market price adjustment amount is expressed in units of at least one of pips, basis points, and a percentage of a market price.

In some embodiments, the act of determining the set of overlapping bid-offer pairs comprises several acts. A determination is made that the bid price and the offer price of each bid-offer pair in the set of overlapping bid-offer pairs is unexpired during the time of interest. The system determines whether any of the bid-offer pairs comprises a bid price that is higher than the offer price of the bid-offer pair. For each bid-offer pair, the system determines that the bid-offer pair comprises a quote spread that is less than a predetermined threshold. A set of qualifying bid-offer pairs is determined from the plurality of bid-offer pairs. The set of qualifying bid-offer pairs comprises each bid-offer pair of the plurality of bid-offer pairs that satisfies each of the following conditions. (A) The bid price of the bid-offer pair and the offer price of the bid-offer pair are both unexpired at the time of interest. (B) The bid price of the bid-offer pair is lower than the offer price of the bid-offer pair. (C) The bid-offer pair comprises a quote spread that is less than a predetermined threshold. A set of overlapping bid-offer pairs is determined from the set of qualifying bid-offer pairs. Each overlapping bid-offer pair comprises a range such that (i) the number of bid-offer pairs having a range that overlaps the range of the bid-offer pair is at least half of (ii) the number of eligible bid-offer pairs minus one, in which two ranges overlap if they both include at least one price in common.

In some embodiments, each bid price and each offer price is associated with a corresponding time duration. In some embodiments, the act of determining that the bid price and the offer price of each bid-offer pair in the set of eligible bid-offer pairs is unexpired during the time of interest comprises determining that the time of interest is within the time duration associated with each bid price and offer price.

In some embodiments, the set of qualifying bid-offer pairs comprises a bid-offer pair from the first user and a bid-offer pair from the second user.

In some embodiments, the offer to purchase comprises a first quantity of units of the first currency, and the offer to sell comprises a second quantity of units of the first currency.

In some embodiments, the first order specifies a first quantity and the second order specifies a second quantity. The act of executing the trade comprises executing a trade between the first user and the second user at a volume equal to the lesser of the first quantity and the second quantity.

In some embodiments, a submission of an order by a user is not revealed to any other user until after the order is executed.

In some embodiments, the exchange rate is equal to the average of the bids and offers in the set of overlapping bid-offer pairs.

In some embodiments, the exchange rate is equal to a time-weighted average of the bids and offers in the set of overlapping bid-offer pairs, in which the bids and offers received at a time closer to the time of interest are weighted more heavily than the bids and offers received at a time further away from the time of interest.

In some embodiment, a selection of a maximum price and a minimum price at which the at least one of the first user and the second user is willing to trade a specific currency pair is received at a user interface from at least one of the first user and the second user.

In some embodiments, an apparatus may comprise at least one processor and a memory that stores instructions which, when executed by the at least one processor, direct the at least one processor to perform various steps. A plurality of bid-offer pairs for a financial product comprising a currency exchange between a first currency and a second currency may be received from a plurality of users of an electronic trading system, the plurality of users may comprise a first user and a second user. Each bid-offer pair may comprise (1) a bid price comprising an estimate of a fair bid price for purchasing the first currency in units of the second currency, and (2) an offer price comprising an estimate of a fair offer price for selling the first currency in units of the second currency. The bid-offer pair may define (a) a range of prices between the offer price and the bid price and (b) a quote spread comprising the difference between the bid price and the offer price. A set of overlapping bid-offer pairs may be determined from the plurality of bid-offer pairs. A market price of the financial product may be determined based on the set of overlapping bid-offer pairs, the market price comprising a rate for converting the first currency into the second currency. A first plurality of orders may be received from the first user and a second plurality of orders from the second user, each order comprising at least one of an offer to purchase and an offer to sell one currency in exchange for another currency. At least one of the first plurality of orders from the first user may be matched with at least one of the second plurality of orders from the second order. A plurality of first trades may be executed between the first user and the second user based on the act of matching, in which each of the plurality of first trades is executed at a current market price determined to be effective at the time of the trade. For each of the plurality of first trades, a change in the market price applicable to each trade may be monitored for a period of time after the trade. For each of the plurality of first trades, an amount representing an extent to which the monitored change in market price applicable to each trade positively or negatively affects at least one of the first user and the second user may be determined. Based on the determined amounts for each of the plurality of first trades, the at least one processor may determine an aggregate transfer amount representing an amount by which the first user was positively affected by the plurality of first trades to the detriment of the second user. The aggregate transfer amount may be transferred from an account of the first user to an account of the second user.

In some embodiments, the system may determine a “flow” or “price flow” indicating a change in price after a transaction that is or would have been advantageous or disadvantageous to one of the parties in the transaction. For example, after a plurality of transactions on the exchange, system may determine and output price flow information. The information may indicate information about a change in the price of products purchased or sold on the exchange, e.g., between two parties. The price flow information may be transmitted to one or more parties, such as the two parties. In some embodiments, the information may be used to provide information about an adjustment in a market price between two users so that aggregate flow between the parties is close to zero over time. For instance, if one user yielded high positive flow against another party during one day, the system may output the graphs and indicate a recommended adjustment in the market price for transactions between the parties in a second day. For example, the recommended adjustment may be an adjustment that, assuming a consistent volume of transactions between the two parties in the second day (and neutral net price flow), the price flow of all transactions between the two days would be close to zero. Thus, if the first user yielded a price flow of positive 0.01 basis points in the first day against a second party, the market price between the two parties may be adjusted in favor of the second party by 0.01 basis points for all transactions between the parties in the second day. (For example, the market price could be adjusted so that the second party buys from the first party at 0.01 basis points below the market price and sells to the first party at 0.01 basis points above the market price, so that the second party achieves a slight price advantage in each transaction.)

In some embodiments, the adjustment amount may be applied to only a portion of transactions between parties, e.g., every other transaction between the parties during a particular period of time. In some embodiments, the system may use a probability function or random number generator (e.g., applying fixed odds) to determine when to apply the adjustment amount, e.g., according to various criteria. For example, the system may determine that the adjustment amount should randomly be applied to 35% of transactions between two parties (e.g., in favor of the second party) during a two hour period, or during a given day.

In some embodiments, the system may measure flow on a running basis (e.g., determine flow between two parties every second or after every transaction). In some embodiments, the system may apply an adjustment amount for various transactions (e.g., transactions between two parties that specified an adjustment amount in favor of the first party, or a class of transactions specified by one or more users or the system) for one or more transactions under various conditions. For example, the system may stop applying an adjustment amount to such transactions upon the occurrence of an event. The event may comprise a determination (e.g., by the system or a user) that the net flow between the parties (e.g., as measured for all transactions of a certain type or a subset of such transactions, e.g., for a particular product, for a particular time period, or other criteria) is zero or within a configurable and/or predetermined threshold of zero. For instance, when a measurement of net flow for a certain type of transactions (e.g., between two parties during a particular day) drops below 0.0001 or 0.000001 basis points (or another amount), the system may stop applying an adjustment amount to such transactions. In some embodiments, the system may start applying an adjustment amount to transactions again once a measurement of the flow exceeds a threshold (e.g., a predetermined threshold or a threshold configurable or determinable by one or more users and/or the system).

In some embodiments, parties may wish to have substantially zero net flow between them over time so that neither has an advantage over the other in the long run. Such a system may encourage users to participate in the system, since the rules of the system may prohibit one party from yielding substantial market gains over another. In some embodiments, users may wish to participate in the system to buy and sell products (such as commodities or currencies) not to make a profit on those products directly, but to hedge a large short or long position in those products, e.g., in another market.

In some embodiments, the system may enable users such as banks to transfer risk, in a variety of sizes designated by the users, largely out of sight of the market.

In some embodiments, liquidity in a particular market (e.g., a currency exchange limited to specific parties such as large banks) may tend to be self-sustaining. In some embodiments, users such as banks may trade currencies on an exchange with anonymity and price transparency. In some embodiments, users of an exchange for a particular market (such as a currency exchange market) may be limited to commercial banks and investment banks. In some embodiments, trading is enabled on a name give-up basis only. In some embodiments, the system may disallow participation by a prime brokerage and may disallow agency trading.

In some embodiments, the system may round decimalized prices, e.g., to avoid spread compression. Mid-point matching of crossed bids and offers so counterparties share price improvements. In some embodiments, the system may specify a minimum initial order size of 2 million base currency.

In some embodiments, the systems and methods described herein may be implemented for a plurality of users of a trading system. In some embodiments, the users may comprise one or more banks, such as commercial banks. In some embodiments, the users may be limited to a group of banks, such as a particular type of commercial bank, e.g., commercial banks having an eCommerce automated hedging system.

In some embodiments, certain types of users may be restricted from participating in the system. In some embodiments, one or more of the following groups or types of users may be prohibited from using the system described herein: aggregators (e.g., aggregator traders), prop trading systems, high frequency trading systems, individual traders (i.e., traders representing a single individual's account or a personal user trading account).

In some embodiments, market data may not be distributed to users. For example, the system may not communicate to users the actual price at which a user's order will trade (e.g., the price may not be output at a user display device). For example, the current price (e.g., the midpoint or adjusted midpoint) may be hidden from some or all users. In some embodiments, users may submit orders for one or more products that do not specify the price of the product, but instead the price may be determined by the system at the time of the transaction. A transaction may occur when one order (e.g., an order to purchase a product in a specified quantity, e.g., 1000 units) pending on the system is matched by the system with a newly received corresponding counter-order (e.g., an offer to sell the same item in a specified quantity, e.g., 5000 units). The system may automatically match the orders and execute them at a market price that is determined by the system, e.g., at the time of execution. For example, the system may determine a market price to be a midpoint or adjusted midpoint price of quotes (as described herein), and the system may calculate such price at the time of execution. In some embodiments, the system may update the market price on a running basis (e.g., as described herein), and execute trades at the most recently determined market price.

In some embodiments, the system may calculate a price defining a mid-point. The midpoint price may be an estimate of a market price of a product, e.g., an exchange rate. The midpoint price may be used as a price to execute a trade. The system may continually (or continuously) or periodically update the midpoint price. Accordingly, the system may calculate a running midpoint price. In some embodiments, the midpoint price (or adjusted midpoint price) may be the only tradable rate in the order book.

In some embodiments, one or more users (e.g., all users or all or a subset of those users eligible to trade in a particular market, such as a market having a “dark pool”) may provide one or more prices to the system. In some embodiments, the prices may comprise market-neutral, non-tradable rate feed comprising one or more prices, such as a bid-offer pair comprising a bid price and an offer price in one currency for one or more financial products such as another currency.

In some embodiments, the system may determine a midpoint price for one product based on the information provided by the users. For example, in some embodiments the system may determine a midpoint based on one or more prices provided by one or more users.

In some embodiments, the system may average one or more quotes (e.g., all quotes or all qualified quotes that satisfy one or more predetermined conditions) from rate feeds to set a mid-point. The system may determine a midpoint a variety of different ways, as described herein.

In some embodiments, one or more prices may be determined to a configured (e.g., predetermined) degree of precision. For example, the system may prompt a user to select (and the user may responsively select) a desired degree of precision (e.g., a number of decimal places such as a third or fourth decimal place), e.g., for one or more types of prices (e.g., price quotes and market prices for a particular product, such as a particular exchange of currencies (e.g., EUR to USD). Users may also be prompted to select and may select, e.g., at a user interface, a type of units such as pips or basis points. In some embodiments, users may specify a different degree of precision for different products (e.g., one degree of precision for USD to EUR and another degree of precision for Yen to USD).

Accordingly, in some embodiments, amounts such as quotes from users and midpoints and other price amounts (such as adjustment amounts) may be determined and communicated to a predetermined level of precision, such as to the nearest 0.01, 0.001, 0.0001, 0.00001, 0.000001, or 0.0000001 units (e.g., of a specific currency, or units of a percentage of a price). In some embodiments, prices may be provided or determined to the nearest whole pip. For example, in some embodiments, a midpoint price and/or an adjusted midpoint price may be determined to six decimal prices. In some embodiments, quotes from users may be received in whole pip increments, and a midpoint may be calculated to a fifth or sixth decimal point. (In some embodiments, a “pip” may be the fourth decimal point, e.g., in foreign exchange trading. For example, a pip may be a “cent of a cent” when expressed in units of U.S. dollars. For instance, if the currency pair EUR/USD is currently trading at 1.4000 and then the exchange rate changes to 1.4010, the pair did a 10 pips move. As an exception, in Yen pairs (GBP/JPY, EUR/JPY, USD/JPY) a pip may be the second decimal place, since a Japanese yen is much closer in size to a cent/hundredth of other major currencies. It should be understood that although various embodiments of the invention are discussed in reference to pips (e.g., the fourth decimal place), other decimal places such as the first, second, third, fifth, sixth, seventh, and eight may also be used instead of a pip.)

In some embodiments, an adjustment amount may be expressed as a percentage of a price. In some embodiments, an adjustment amount may be expressed as an amount of a specific currency (e.g., $0.0000025). In some embodiments, an adjustment amount may be rounded to a specific decimal place (e.g., a second decimal (e.g., cents on a dollar), a third, fourth, fifth, sixth, seventh, or eighth decimal place).

The system may receive orders from users, such as bids and offers. The system may match bids for one type of product against offers for the same product (and vice versa) at the determined mid-point rate at the time of match. In some embodiments, the trading system may use features of known trading systems such as those described or referenced herein. Bids and offers may be submitted to the system at one or more different times, such as any time desired by the user or at specific times designated by the system (e.g., every hour on the hour).

In some embodiments, the system may enable the purchasing and selling of one or more products or services, such as financial products. Financial products may comprise one or more stocks, bonds, currencies, commodities, futures, options, and other derivatives and financial products. For example, the system may enable users to exchange one or more amounts of one currency in exchange for one or more amounts of another currency, e.g., at an exchange rate.

In some embodiments, the system may accept orders for a product that specify a size but not a price or rate. (For example, the system may ignore a price/rate if one is provided.)

In some embodiments, the system may require a minimum duration of an order, such as one second, two seconds, five seconds, thirty seconds, one minute, two minutes, five minutes, fifteen minutes, half hour, an hour, etc. In some embodiments, a relatively long minimum duration may discourage users from submitting orders on the system's trading system as well as other venues. In some embodiments, the system may require a minimum size (e.g., volume) for an order. (E.g., the system may reject any order below a predetermined size, or the system may be configured so that only orders above a certain size may be entered or submitted to the system.) For instance, a minimum order size may be 1/32 of one unit, ½ of one unit, one unit, 500, one thousand, one million, two million, five million, ten million, of another number of units (e.g., of a product such as a financial product, e.g., a currency). In some embodiments, different products may have different minimum order sizes (e.g., one million dollars in a dollar/euro exchange, and ten million pesos in a peso/dollar exchange).

In some embodiments, users may know the identity of all users eligible to trade in a particular market (e.g., a market for foreign currency). In some embodiments, the system may not disclose which user submitted a particular order. In other words, the identity of the user who submitted an order may remain hidden.

In some embodiments, users may comprise one or more commercial banks that communicate quotes and orders directly to system, e.g., without an intermediary such as a broker or agent.

In some embodiments, changes requested or required by a user (such as a bank) may include orders without price (in which the system may ignore a price if submitted by a user for particular types of orders, such as orders for which a price is determined by an algorithm as described herein) and how to handle minimum time duration of orders.

In some embodiments, users may have two different user IDs for interacting with the system. In some embodiments, the system may require a first dedicated user ID for non-tradable market-neutral rate feeds (e.g., in whole pip spreads). In some embodiments, the system may require a second dedicated user ID for submitting orders.

In some embodiments, the system may impose a default setting that an order user ID cannot trade with itself.

In some embodiments, the matching engine may cancel indicative rates after time-to-life (TTL) expiry to prevent the use of a “stale” (e.g., outdated) rate in calculating a mid-point price (e.g., on a continual basis). (A time-to-life expiry may comprise a default or user-specified period of time until expiration such as 2 seconds or 5 seconds.) For example, in some embodiments, the system may cancel a price received from a user (e.g., a bid price, an offer price, a quote comprising both a bid and an offer, etc.) based on a time associated with the price. For example, a time associated with a price may comprise a time at which a price is specified, a time at which a price is submitted, a time at which a price is received, a TTL (time-to-life) associated with the price, an expiration time (e.g., specified by a user or the system), or a time associated with a condition (such as good-until-cancelled or updated).

In some embodiments, the system may cancel a price that is associated with a time that is before a time of interest (e.g., a current time) by an amount of time (e.g., a predetermined amount of time or a configurable amount of time). The amount of time may be a default amount of time (such as 2 or 5 seconds), a user-specified amount of time (such as 2 seconds or 5 seconds), or a configurable amount of time that may depend on one or more factors. For example, in some embodiments, the system may automatically cancel a price a particular amount of time (e.g., five seconds) after it is received by the system or a particular amount of time after it is submitted by a user. In some embodiments, the system may cancel a price when an updated price is received (e.g., from the same user for the same type of price (e.g., bid or offer) for the same product). For example, the system may cancel a bid of a bid-offer pair (or the entire bid-offer pair) when it receives an updated bid price from that user for the same product.

In some embodiments, if a rate feed (e.g., a series of rates received from a particular user) refreshes only one side of a spread (e.g., only a bid or only an offer), the trading system may automatically extend life of the non-refreshed bid or offer for TTL (time-to-life, e.g., time to expiry). Accordingly, in some embodiments, when the system receives an updated bid from a user, the system may update only the bid part of a pending bid-offer pair from the user and maintain the offer price (of the bid-offer pair) if it is otherwise valid (e.g., unexpired).

In some embodiments, the system may continue calculating mid-point with remaining feed(s). For example, the system may continuously update midpoint calculations by continuously (or continually) running a midpoint calculation algorithm (e.g., as described herein). For example, a midpoint calculation may be updated each time the data changes state (e.g., new data is received, data expires, an order is received, an order is cancelled, or another event related to a market occurs).

In some embodiments, the system may cancel one or more orders and/or reject one or more new orders under one or more conditions. For example, if all rate feeds disconnect from trading system, the system may cancel all orders immediately, e.g., regardless of the TTL of any order or quote.

In some embodiments, when an order feed from a particular user disconnects from the system, the system may automatically and immediately cancel all orders from that user, e.g., regardless of the TTL of any order or quote. In some embodiments, the system may also ignore the user and any quotes or other information submitted by that user for specific purposes, e.g., for purposes of aggregating quotes to determine a market price.

In some embodiments, the system may not allow trade setting.

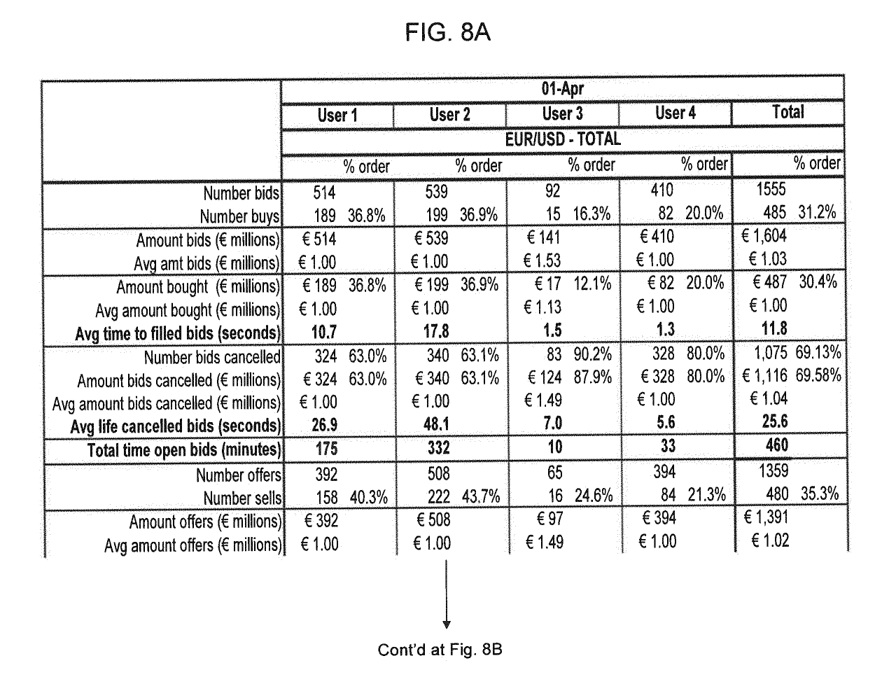

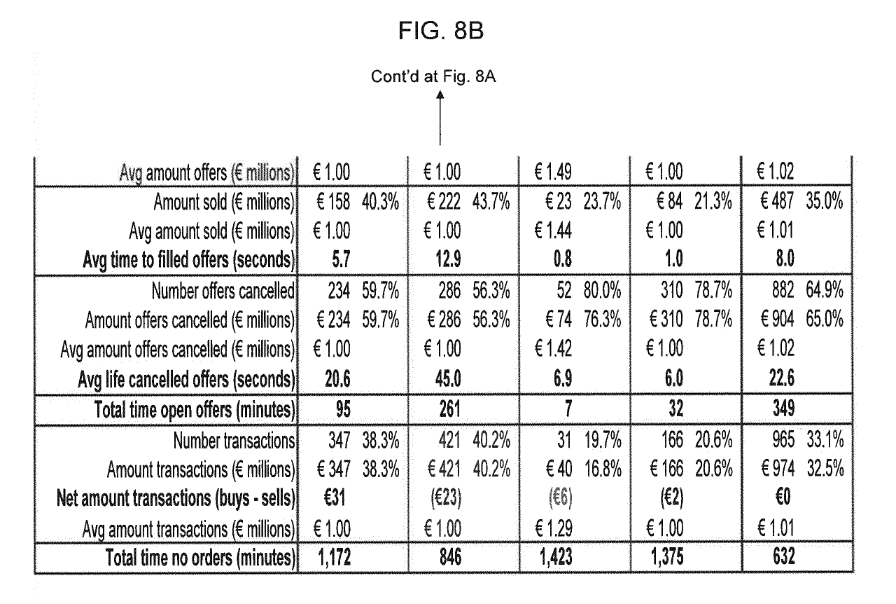

In some embodiments, users (e.g., one or more banks) may agree to share data, such as market data. For example, the users may agree to disclose the identities of all user participants of a particular market (such as a currency exchange for bank users). The users of the market may also agree that the source of any order should remain anonymous, e.g., based on one or more conditions. For example, the source of an order may remain anonymous until the order is executed. In some embodiments, users may not know about the source or presence of any other order until the user's order is executed. In some embodiments, the source of any order may remain anonymous at all times. However, in some embodiments, users may receive aggregate data about each user (e.g., as described with respect to any one or more of FIGS. 8A-14).

In some embodiments, a market price (e.g., a running midpoint market price) may be calculated as follows. The market price may be used for executing trades between users (e.g., trades for orders that do not specify a price, or for which a determined market price is used instead of any price submitted by a user). In some embodiments, an algorithm to determine the price may use some or all of the following rules. (The following description of the rules and other features described herein may specify a particular type of user, such as banks. However, it should be understood that a bank is only one type of user for which these rules and other features described herein may be implemented.)

Rule 1: Reject all inverted quotes. An inverted quote may comprise a bid price in a pair with an offer price that is lower than the bid price submitted by a particular user for a particular product and intended by the user to be valid at the same time. In a typical valid bid-offer pair, the bid price is higher than the offer price.

Rule 2: Reject all quotes with wide spreads (e.g., in which threshold rejected spread amount is configurable by product (e.g., currency pair) and by counterparty). For example, a quote having a spread greater than an amount such as $0.05 (e.g., from a specific user for a specific product such as a USD/EURO conversion) may be rejected, whereas quotes having a spread of $0.04999 or less may satisfy this rule.

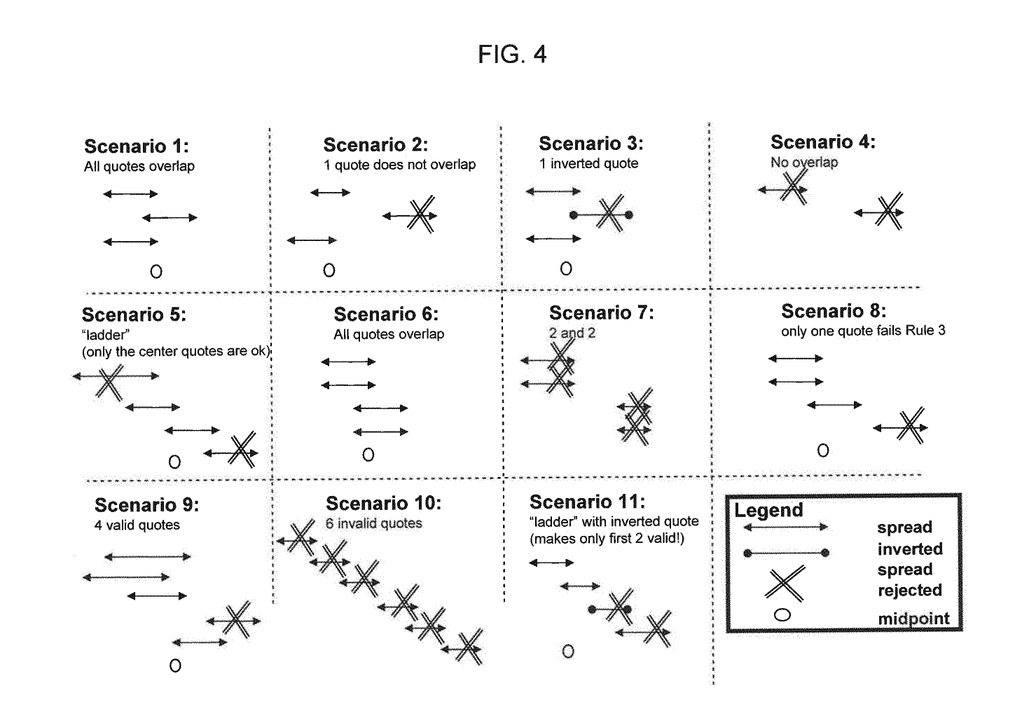

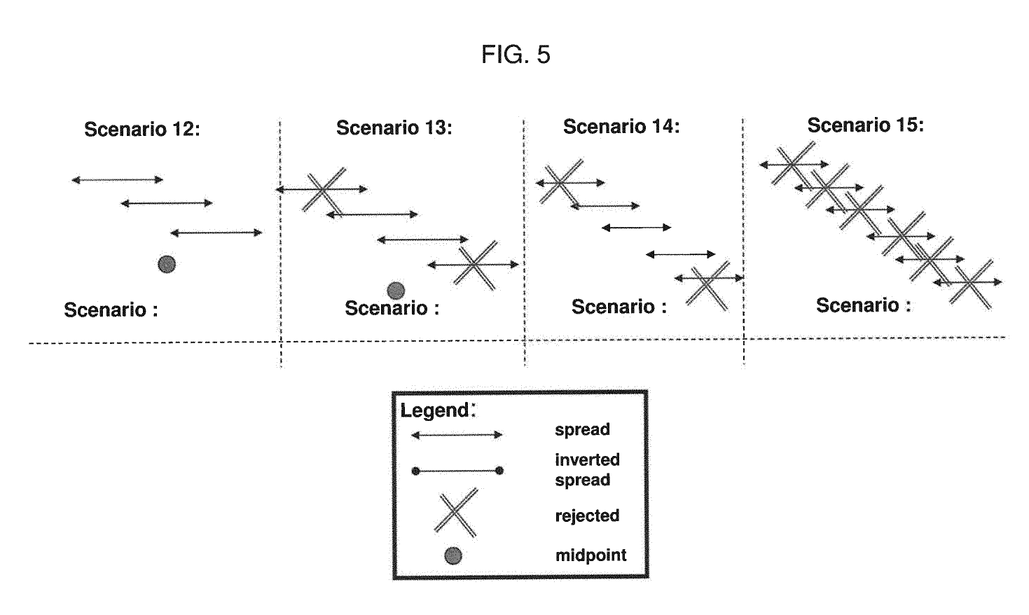

Rule 3: After applying rules 1 & 2, to calculate mid-point, average together only remaining quotes from users (e.g., banks) that overlap with 50% or more of other remaining quotes. For example, the scenarios described with respect to FIGS. 4 and 5 show exemplary determinations of a midpoint price based on such otherwise qualified and “overlapping” quotes. In some embodiments, for user (e.g., bank) 1 to overlap with user (e.g., bank) 2, the bid of user 1 must be less than or equal to the offer of user 2 and the of user 1 must be greater than or equal to the bid of user 2.

For each bank, count the number of other banks with which its quotes overlaps and calculate the percentage (%) of (1) overlapping banks divided by (2) the number of all remaining banks. (The bank itself is not included in calculating the percentage. For example, if there are four banks, and the quote from bank 1 overlaps with the quotes from banks 2 and 3, but not with the quote from bank 4, the percentage is 66.6%, i.e., 2÷3.)

To calculate the midpoint, average together only the quotes from banks which overlap with 50% or more of remaining banks. In some embodiments, the average can be a straight average (a mathematical mean). In some embodiments, the average can be weighted according to one or more of a variety of factors such as the time at which a quote was received, the identity of the party who submitted the quote (e.g., the quotes of some users may be weighted more heavily than those of other users), size of the user (e.g., market cap of a user bank), system usage by the user (e.g., the user's number of trades or trading volume in the system, e.g., in a specific period of time such as daily, e.g., for trades of the quoted product).

If there are no banks with overlapping quotes with at least 50% of remaining banks, then the system may determine that there is no midpoint. (For example, 2 banks having quotes with no overlap, 4 banks wherein bank 1 overlaps bank 2 only, bank 3 overlaps bank 4 only. Here, the percentage would be 1÷3=33%. Each percentage is 33% which is less than 50%.)

In some embodiments, the system may eliminate the rule to drop low bid and high offer quotes based on a determination that one or more conditions exist. The one or more conditions may comprise a determination that the system is receiving at least a predetermined number of rate feeds, such as four, five, six, seven, or another number.

In some embodiments, one-sided prices may be rejected. A one-sided price may comprise a bid without a corresponding valid offer or an offer without a corresponding valid bid. In some embodiments, any quote that does not include both a bid and offer (e.g., at the same time) may be rejected.

In some embodiments, users may directly measure (and/or may request the system to measure) the flow of transactions with one or more (e.g., all) of their counterparties (e.g., counterparties to a trade between the user and the counterparties), e.g., periodically. If a user determines that a counterparty's flow is consistently unprofitable for the user, the user may then choose to take action that may tend to reduce or eliminate the likelihood of unprofitability with that party in the future, e.g., by widening spreads quoted or by not trading with that counterparty, for example. In some embodiments, an adjustment amount may be determined (e.g., by one or more users and/or the system) for future transactions between the user and the counterparty. Adjustment amounts may similarly be determined for the user with a class of counterparties (e.g., all counterparties associated with a particular entity, one or more particular trading behaviors, one or more particular markets, one or more particular products, one or more particular trading volumes, or any other criteria identified herein), a type of transaction (e.g., transactions for a particular product or in a particular market), or another criteria associated with one or more trades. If flow for transactions fitting the criteria is “unprofitable” for the user, the system and/or the user may determine an adjustment amount. The adjustment amount may be applied in the user's favor for future transactions that fit the same criteria (e.g., all transactions associated with a particular product or on a particular market). In this way, a user may attempt to achieve a particular aggregate value of flow (e.g., for all transactions or a particular type of transaction, e.g., for a particular product or with a particular counterparty) that is equal to or within a threshold of a particular flow value (such as zero or a threshold near zero).

In some embodiments, the system and/or users such as banks may calculate flow counterparty profitability in one or more of a variety of ways. In some embodiments, the system and/or one or more users may take a sample of several transactions (e.g., hundred to thousands of transactions), and then revalue each transaction at the market mid-point rate at regular intervals subsequent to the trade at 500 ms, 1 sec, 2 sec, 5 sec, 10 sec, 30 sec, 45 sec, 60 sec, and 2 min after the trade (and/or any other time interval). The system and/or one or more users may then produce a flow graph or other interface that shows the subsequent average profitability of those trades (e.g., with an indication of the standard deviation). The system and/or one or more users may expect the graph to be relatively flat (e.g., within reasonable error boundaries). If the graph shows a considerable negative effect (e.g., −0.2 to −0.5 pips), the system and/or one or more users may consider such flow to be “bad flow”.

In some embodiments, the trading system may facilitate the exchange of countervailing risk at a fair price (market neutral midpoint). In some embodiments, participant banks may expect flow from transactions effected on MIDFX with other participants to be neutral (flat curve).

In some embodiments, users may incur risk as a consequence of trading with many different counterparties through many different channels, some deemed “good” by the user and some deemed “bad” by the user. In some embodiments, to ensure orders delivered to the exchange will result in “good flow” for the user, the user may desire to filter out the transactions having (or likely to have) “bad” flow. This can require work and the use of scarce resources.

In some embodiments, banks may have a willingness to trade with “bad flow” counterparties if the rate (e.g., price) at which transactions are matched is adjusted to offset the potential “losses” (e.g., negative flow as determined based on the market price after the transaction). (For example, transactions may be adjusted by one or more adjustment amounts, as described herein.) If the adjustor is the counterparty suffering the loss and the adjustee is the counterparty taking the profit, then all adjustor's buys from the adjustee will be executed at the midpoint minus (−) the adjustment amount and all adjustor's sells to the adjustee will be executed at the midpoint plus (+) the adjustment amount. In some embodiments, only a portion of transactions (e.g., a set of transactions randomly selected) between the adjustor and adjustee may be adjusted.

In some embodiments, flow curves may be generated by counterparty pair. In some embodiments, the system may calculate the rate adjustment required to correct each curve to neutral.

In some embodiments, participants may be enabled to agree amount and duration of adjustment to be applied.

In some embodiments, instructions may be transmitted to the Trading System, e.g., by one or more users.

In some embodiments, the trading system may execute the instruction and deliver both midpoint and execution rates to one or more users.

In some embodiments, the system may generate flow curves and calculate adjustment: at specified configurable intervals (every: day, week, x hours for example); for specified counterparty; for a specified configurable number of transactions (last 100, 500, 1000 trades, etc or all trades from specified start time or for time period from xx:xx hours to yy:yy hours, for example); for specified counterparty (including all); for all transactions taken together and for each currency pair.

In some embodiments, the system may calculate the adjustment to the executed midpoint required to flatten overall curve to neutral and adjustment to each currency pair that taken together would bring overall curve to neutral. In some embodiments, the system may show statistical error bands for which no adjustment is necessary (+/−0.000005 for example). In some embodiments, the Mid-point and adjustment may be calculated to 6 decimals (configurable), e.g., with some exceptions. In some embodiments, the system may specify the elapsed time the adjustment should be in place.

For example, the system may specify an adjustment such that when BANK A buys from BANK B (or Bank B sells to Bank A), the market rate is increased by (+) 0.000016. And when BANK A sells to BANK B (or BANK B buys from BANK A), the rate is decreased to (−) 0.000016. This may be effective for a specified time (e.g., FROM: dd mm yyyy hh:mm:00—TO: dd mm yyyy hh:mm:00).

In some embodiments, the system may enable counterparties to view flow graphs and agree midpoint rate adjustment.

In some embodiments, algorithms used by the system to output flow graphs and calculated mid-point adjustment (e.g., to counterparties at one or more user interfaces) may include any method of communication disclosed herein, such as email, a secure web site (e.g., a system web application site).

In some embodiments, the system may enable users to configure a rate adjustment, e.g., at a website or via email. For example, one or more users may receive a suggested adjustment amount, e.g., at a user interface or in an email (e.g., from the system or from another user such as a counterparty). The one or more users may decline, approve, or change the suggested adjustment amount or enter a new adjustment amount. The one or more users may send or otherwise communicate (e.g., via email or at user interface, e.g., at a website) the declination, approval, or change (e.g., via an approved or changed adjustment amount). The one or more users may also change one or more parameters associated with the adjustment amount, such as parameters defining the transactions to which the adjustment amount would apply (e.g., the type of products, the frequency (e.g., 1 in every two transactions of a particular type), the counterparties to whom it will apply, the time duration over which it will be applied, and any other parameter that may be associated with an adjustment amount). Similarly, the system may enable users via email or on web site (or via other communication means, e.g., any communication mechanism described herein) to show agreement to rate adjustment.

In some embodiments, users may provide mid-point rate adjustment data to the system.

In some embodiments, a rate adjustment may be entered manually or automatically (e.g., by the system or by a user).

In some embodiments, a confirmation of trade may be sent to each counterparty may include both the rate (e.g., price) at which a trade executed and also the then-current price. For example, if the price is calculated as a “midpoint” of various bid-offer pairs, the trade confirmation may comprise the trade price (e.g., the price at the time of the trade) and the current price (e.g., at the time of transmission). Such information may be disclosed to parties in a trade confirmation or other communications. In some embodiments, users may access such data online, e.g., at a secure website hosted by the system.

In some embodiments, to ensure banks are meeting mutual expectations of behavior, they may agree to share data of their activity on the trading system.

In some embodiments, the system may occasionally distribute to users data regarding non-tradable rate feeds used to calculate the running mid-point. In some embodiments, the system may distribute to users order data and a volume graph. In some embodiments, the system provides such information over a restricted access web site.

In some embodiments, the system may generate hourly reports via email. In some embodiments, the system may receive streaming non-tradeable rates from ten banks. The system may remove extremes to calculate average midpoint. In some embodiments, the system may filter out hedging requirements from toxic counterparties so that these do not affect the midpoint calculation.

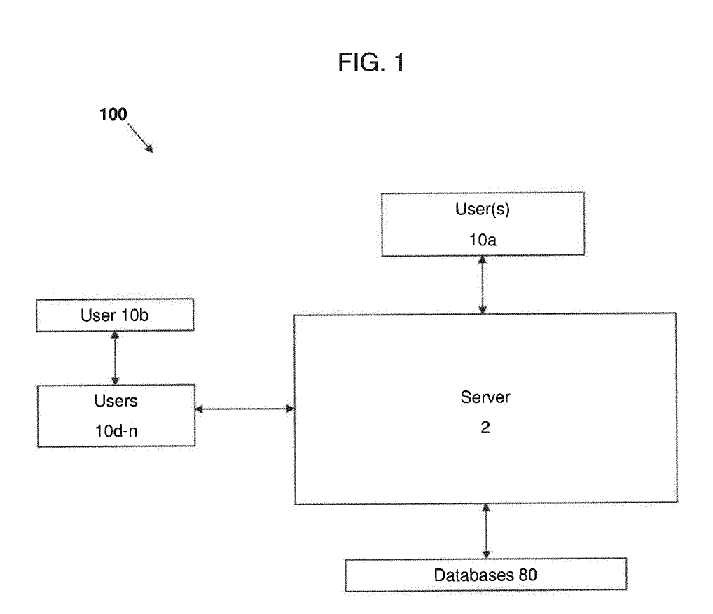

FIG. 1. Exemplary System for Determining a Market Price

Some embodiments of the present invention provide systems and methods for determining a market price.

Server 2 may comprise one or more processors, computers, computer systems, computer networks, and or computer databases. Server 2 may comprise modules 18-64. Server 2 may also comprise one or more databases, such as databases 80. Server 2 may communicate with users 10. For instance, server 2 may communicate with a user 10 computer, such as a browser of a user computer, e.g., over the internet.

Modules of server may comprise one or more processors, computers, computer systems, and/or computer networks.

Databases 80 may comprise one or more processors, computers, computer systems, computer networks, and/or computer databases configured to store information. Each of databases 80 may communicate with server 2 and modules. For instance, server 2 and modules may store information in databases 80 and may also use information stored in databases 80.

FIG. 1 depicts a system 100 for determining a market price.

The system 100 may comprise one or more servers 2 coupled to one or more databases 80, one or more data providers 8a-8n, and one or more end users 10a-10n. The data providers 8a-8n, users 10, agents 12, and server 2 may each communicate with each other. Users 10 may also communicate with other users 10, e.g., regarding one or more orders or market prices. For example, a user 10a may propose to engage in a transaction with another user 10b to buy, sell, or exchange one or more securities of user 10a. For example, the system may determine a market price of a product.

In some embodiments, the system 100 may communicate with users 10a-10e and operate as (or communicate with) an exchange so that users 10a-10e may submit orders and execute trades with other users of the exchange. For example, the system may incorporate and/or utilize the computer systems, user interfaces, and other features and functionality as disclosed in U.S. Pat. No. 6,560,580 and U.S. patent application Ser. No. 09/801,495 filed Mar. 8, 2001, Ser. No. 10/301,527 filed Nov. 21, 2002, Ser. No. 10/699,858 filed Oct. 31, 2003, Ser. No. 11/122,510 filed May 4, 2005, and Ser. No. 12/189,266 filed Aug. 11, 2008, and Ser. No. 12/464,099, filed on May 11, 2009, the disclosures of which are incorporated herein by reference in their entireties; however, to the extent that any terms used in those patents applications have meanings that contradict or otherwise conflict with the meanings used in the present application, the terms and meanings used in the present application shall control the meanings of the terms used in the present application, and the meanings of the terms used in the other patents and applications shall be construed in accordance with their respective disclosures.

Users 10a-10n may comprise one or more persons, companies, financial entities, representatives, or other entities. A user 10 may be associated with one or more orders. For example, user 10 may own or control one or more orders in an account associated with the user 10 in a database. As used in this application, a user 10 may also refer to a user's interface to other system 100 components (such as server 2).

For example, a user's 10 interface may comprise a user's PDA or computer, or a program running on a user's computer such as a computer web browser like Internet Explorer™, which may communicate with data providers 8 and/or server 2. A user's 10 computer may comprise one or more processors, memories, and input and output devices for communicating with other modules, databases, and other system elements. A user's 10 computer and interface may comprise functionality to select one or more orders and portfolios, and parameters (as described below). User's 10 computer may also comprise trading functionality to view and submit bids, offers, lifts, and takes. In some embodiments, user's 10 computer may comprise all the functionality of trader terminals known in the art, such as those used to trade over the New York Stock Exchange, NASDAQ, and eSpeed platforms.

The server 2 may comprise a computer, server, hub, central processor, or other entity in a network, or other processor. The server 2 may comprise input and output devices for communicating with other various system 100 elements. In some embodiments, the server 2 may be comprised in an end user's computer 10. For example, server 2 may operate as a toolbar in a user's web browser or another program running on the user's computer. In some embodiments, the server 2 may comprise a plurality of servers and/or computers.

The server 2 may comprise a plurality of modules. Each module may comprise one or more processors, memories, and input and output devices for communicating with other modules, databases, and other system elements. In some embodiments, functions described herein for a specific module may be performed by a specific module or by the server 2.

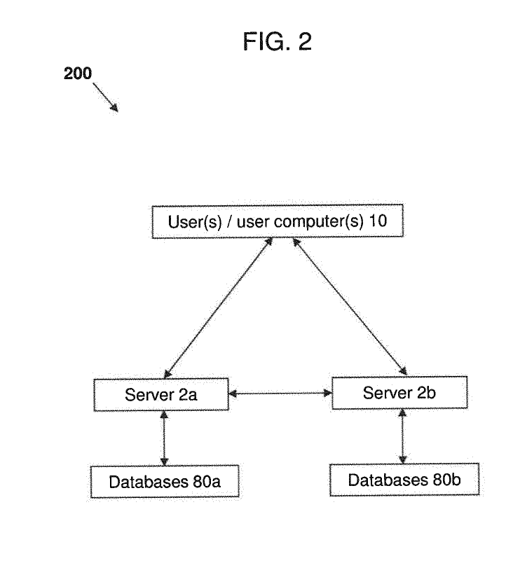

As shown in FIG. 2, server 2 may comprise two servers 2a and 2b, in which each server 2 has a corresponding database 80a and 80b.

The server may comprise various modules for accomplishing various functions described here.

For example, user interface module may communicate with users. User interface module 18 may communicate with users so that users can set up an account, log in to an account; prompt a user to submit preferences concerning one or more payments and/or orders; receive user preferences and selections concerning one or more payments and/or orders; communicate with users to provide information regarding one or more payments and/or orders; or receive any other inputs from user and output any other outputs to user, as described herein.

User interface module may cause information to be output to a user, e.g., at a user output device such as a display device (e.g., a display device at a user terminal), a speaker. The information outputted to a user may be related to a user account, one or more payments and/or orders, preferences, and other information described herein. User interface module may communicate the information electronically, e.g., via networked communication such as the internet (e.g., in an email or webpage), telecommunication service, etc.

User preferences module may receive, identify, or determine user preferences concerning one or more payments and/or orders. For instance, the module may receive the preferences from a user interacting with a user interface. The module may also receive preferences from an automated user terminal. The module may also determine preferences based on a program that automatically determines user preferences concerning one or more bids, offers, orders, accounts, or other information. User preferences may include preferences that are related to, or that specify, any of the following with respect to one or more payments or orders: estimated fair price; market price; calculation of market price by the system; approved or disapproved counterparties (e.g., counterparties who are eligible or ineligible to trade with a user); duration of monitoring a price; an adjustment amount, e.g., for trades with one or more other users; volume of orders (e.g., minimum and maximum orders); and any other preferences (e.g., as described herein). In some embodiments, user preference module may receive from the user (e.g., at a user interface) a selection of one or more preferences related to an adjustment amount, such as adjustment amount criteria (as described herein), an adjustment amount, flow graph criteria, minimum thresholds related to a flow graph or adjustment amount, a desired area or integral of a flow graph, and other preferences related to flow or any information related to flow (e.g., as described herein).

User account module may create and manage a user account. In some embodiments, the user account may be a financial account such as a trading account, investment account, or other financial account. Accordingly, in some embodiments, user account module may operate similarly to an online brokerage account, such as those offered by e*Trade, Ameritrade, Schwab, etc. In some embodiments, user account module may determine information about a user's holdings based on the user's 10 order book.

Financial information module may determine financial information associated with one or more users, one or more currencies, one or more exchange rates, one or more market prices, one or more securities, one or more portfolios, one or more business enterprises (such as a company, partnership, corporation, etc.), and other financial information. The financial information may comprise any current, historical, and predicted financial information that may be relevant to the one or more users, one or more currencies, one or more exchange rates, one or more securities, one or more portfolios, and one or more business enterprises. For example, financial information may comprise current, historical, and predicted information concerning interest rates, prices of one or more entities (e.g., securities such as orders), and/or any other financial information. For instance, with respect to a financial entity such as a company (e.g., a bank) or financial instrument such as an order (e.g., an order to exchange currency), financial information may comprise past, present, or predicted information concerning any of the following: market capitalization, price, earnings, volatility, volume traded during a time period, number and type of issued securities outstanding, dividends paid, highest or lowest price in a period, percentage of institutional ownership, beta, coupon value, issuance price, purchase price, market price, prices of related derivatives (e.g., calls, puts, and futures of a order), interest rate spread against U.S. treasuries, par, maturity, payment record (extent to which an issuer has timely paid all prior schedule payments), industry data, comparable company data, exchange rate to another currency, one or more government interest rates or changes in interest rate (e.g., a cut in a Fed rate), earnings, information in a financial report by an analyst or company (such as a 10Q, 10K, 8K, or other report or analysis), company debt, company assets, total cash and reserve, predicted time or likelihood of default, volatility of stock or bond price, volatility of market (e.g., one or more market indices such as the DJIA), information based on such financial information (such as a price to earnings ratio), exchange that trades the instrument, rating of an instrument or company by an entity (such as Moody's, Fitch's, or Standard and Poor's), an index (such as a broad market index or global sovereign index), a Treasury yield curve, a renegotiation or attempt to renegotiate terms of payment for a order, an announcement that a credit rating agency is seeking to review a prior rating of an issuer, and any other financial information. Financial information may also comprise more general information relating to the market or the economy (in the past, present, or predicted future), such as consumer credit information, the consumer price index, a government (e.g., U.S. federal government) budget balance, housing starts, jobless claims, unemployment rate, and other financial information.

Price module may determine and associate one or more values or prices with one or more estimates of a fair market bid or offer or an actual order by a user. Prices may include a current price, a historical price (e.g., a price such as a market price at a prior time, such as a week earlier or an original date of issuance of a order that pays a plurality of payments), and an estimated future price. In some embodiments, price module may determine a purchase price of one or more instruments.

In some embodiments, price module may derive a price (e.g., an estimated current market price) for an order (e.g., an order to buy or sell one currency in units of another currency) using financial information, e.g., as known in the art. For instance, such a price may be derived from information such as a current market bid and/or offer price of the order on an exchange, and other financial information (e.g., a prediction about a change in an interest rate, e.g., in a particular country). In this way (and according to methods known in the art), price module may determine prices such as exchange rates.

In some embodiments, price module may allocate one or more portions of a purchase price of an order (or series of purchases over time for the same order) to a plurality of payments of the order (e.g., past, present, and future payments related to the purchase price). For example, portions of a purchase price may be allocated to payments in a similar manner or ratio as a market price may be allocated to the payments.

Parameters module may determine parameters or other criteria for one or more payments and/or orders. For instance, parameters module may determine search parameters for finding securities (e.g., orders) and/or one or more sets of payments that satisfy user preferences and/or hedge criteria. Parameters module may determine parameters based on input from a user 10 or other information. For example, parameters module may receive parameters or selections of parameter values from a user, e.g., based on prompts from the server 2. Parameters may comprise financial information (as described above) including, e.g., information about targeted payment dates, industry sectors, payment amounts, preferred issuers, preferred balance between asset classes, other desirable features of a portfolio described herein, and other financial criteria.

Exchange module may operate a trading exchange or trading system in which users 10 may buy and sell financial instruments such as orders. The trading exchange may have functionality similar to the New York Stock Exchange, the Chicago Mercantile Exchange, NASDAQ, and other exchanges known in the art. The trading exchange may comprise the eSpeed™ platform.

In some embodiments, exchange module may buy and sell assets in a portfolio, such as currencies. The system may do this automatically. For instance, a user may specify that the system should purchase one or more currencies. The user may specify various parameters, e.g., quantities that should be purchased at a specific time or during a specific time period (e.g., 20 million dollars in exchange for yen from noon to 1 μm).

The various modules may function separately or in various combinations. The modules may communicate with a plurality of databases, which may also function collectively or separately.

The modules of server 2 may store, access and otherwise interact with various sources of data, including external data, databases, inputs, and other sources of data.

Databases

One or more databases 80 may be coupled to the server 2. The database 80 may comprise a plurality of databases as described below. Databases 80 may store any information described herein about users, modules, financial information, market prices, and other information. For example, database 80 may store information associated with a user and a user account, such as a user name, account security information such as a password or code, and user preferences, e.g., regarding one or more parameters. For any user having a financial account, the database may store information about the user account, such as one or more orders and other securities associated with the user. Such instruments may include instruments owned by, controlled by, and/or selected by the user, and/or instruments that satisfy one or more criteria associated with the user (e.g., parameters selected by the user or associated with the user based on user information such as a preference determined by a processor).

Database 80 may store hedge information associated with one or more orders, payments, and/or groups of orders and/or payments.

While the databases are shown coupled to a single server, the databases may also operate among several servers. The databases may communicate with a plurality of modules and servers, which may also function collectively or separately to perform the features and functions described here.

An Exemplary Method

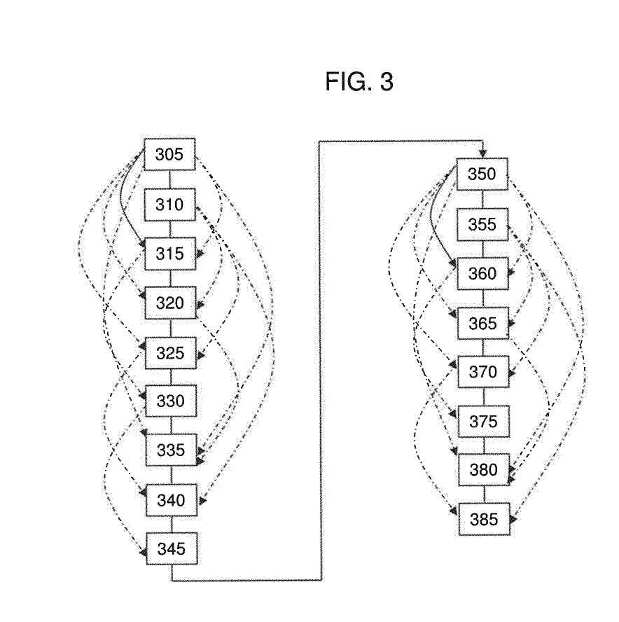

FIG. 3 depicts a flow diagram according to at least one embodiment of the methods disclosed herein. It should be understood that each function(s) described for each block may be performed using a module capable of performing that function, e.g., according to methods described for each module above.

In block 305, the system 100 may receive login information, e.g., from a user. For example, the user may access the system to log in to an account of the user managed by the system. The login information may be any information for use in authenticating a user and providing thereto one or more of the functions disclosed herein. The login information may be, for example, a user ID, password, biometric data, etc. The login information may be submitted by a user with a user interface screen that includes therein at least one form element, such as an input field or text box, a drop down list, check box, radio buttons, action buttons, clickable images, etc., for entering login data. Following submission, the login information may be compared with previously obtained information and access to one or more of the functions may be provided based on a positive match.

In block 310, one or more bid and/or offer prices may be received, e.g., from users, e.g., for a particular product such as a currency conversion. The bids and offers may comprise an estimate by a user of a fair market price bid and offer for the product, and need not be an actual bid or offer price from a user.

The bids and offers may comprise a plurality of bid-offer pairs, each received from a user. The bid-offer pairs may be received continually from each user. The bids and offers may be received from a user at the same time or at different times. In some embodiments, a user may be deemed to have a presently valid bid-offer pair if the user has submitted a bid and offer for a particular product within a predetermined time frame of the present. The user may submit new bids and offers to replace prior bids and offers.

In block 315, one or more bids and offers may be rejected. For instance, a bid from a user having no valid corresponding offer from the user may be rejected. The bids and offers may be rejected according to any rules discussed herein. For instance, expired bids and offers may be rejected (e.g., a bid or offer that is received after a time of validity for the bid or offer specified by the submitting user).

In block 320, a fair market price may be determined for a product. For example, a fair market price may be determined from an average of the valid bid-offer pairs for the product.

In block 325, a fair market price may be updated. For example, additional bid-offer pairs from additional users or updated bid-offer pairs may be received. The fair market price may be recalculated based on the updated information.

In block 330, one or more orders may be received by the system, e.g., from one or more users. The orders may comprise offers to purchase or sell the product. Each order may specify a bid to purchase or an offer to sell a quantity of the product. The orders may not specify a price in some embodiments, as the price may be determined by the system.

In block 335, one or more users may be disconnected from the server. For such users, all bid prices, offer prices, and orders from the user may be rejected.

In block 340, the fair market price may be recalculated based on the updated information (e.g., the disconnected user).

In block 345, additional orders may be received, e.g., from one or more users. The orders may be submitted via one or more user terminals to an electronic exchange in the system. In some embodiments, the orders may specify a product (such as a particular currency exchange) and a quantity, but not a price. In some embodiments, a user may wish to trade one or more products only with specific other users (or not trade with specific other users). Accordingly, the user may specify a list of eligible counterparties (or ineligible counterparties) in a user profile, or in a specific order (e.g., if a specific order has a specific set of eligible and/or ineligible counterparties).

In block 350, the system may match one order with another order. For example, the system may match a bid with an offer for the same product. In some embodiments, the system may match orders and corresponding counter-orders based on the eligible parties associated with the order.

In block 355, the system may execute a trade based on the matched orders (e.g., an order and a matched counter-order). In some embodiments, the trade may be executed at a fair market price determined by the system at the time of matching (e.g., a calculated midpoint, or a calculated midpoint adjusted by a determined or default adjustment amount).

In block 360, the system may send a confirmation of the trade, e.g., to the two parties who traded.

In block 365, the system may monitor the market price of the product traded. For example, if the trade comprises a purchase of a product (e.g., a purchase of a stock or bond, or a purchase of dollars in exchange for Euros), the system may monitor a price associated with that product. The monitored price may comprise a fair market price as determined by the system for the product on a continually updated basis. The price may be monitored for a period of time, such as a time predetermined by the system, and/or a period of time specified by one or more users, such as one or more parties to the trade. For example, users may transmit to the system a preference for a period of time of monitoring.

In some embodiments, the system may calculate a flow rate between and/or among two or more parties for one or more transactions, e.g., a price flow for two transacting parties over the course of one week.

In block 370, the system may determine an adjustment amount based on the flow data. For example, the system may determine that an adjustment amount is 0.02% of a price (e.g., 2 basis points of a price). The system may determine the adjustment amount in any manner as described herein.

In block 375, the system may transmit the flow information, including the adjustment value, to the users. For example, the system may show flow information between two users to the two users at an interactive interface (e.g., touch-sensitive screen) of each of the two users. The system may provide the adjustment amount as a suggested adjustment amount for future transactions of a particular type between the two users. The system may display a selectable icon representing the adjustment amount to the two users. If one user (or in some embodiments, both users) select the suggested adjustment amount, the system may adjust future market prices for trades between the two users by the suggested adjustment amount, e.g., for a predetermined period of time such as one day or one week, or for a period of time selected by one (or both) users via one or more icons representing time at the user interface.

It should be appreciated that parties such as banks may use historical measurements of flow (e.g., for a prior day's or week's transactions of a particular type, such as transactions with a particular party) to predict future measurements of flow, e.g., for transactions of a similar type. Accordingly, banks may prefer the system to suggest adjustment amounts for future transactions that are calculated based on flow amounts that would have been proper for the historical period of interest (e.g., the prior day).

In block 380, the system may receive an adjustment value from one or more of the users. The users may specify that the adjustment rate is active only until the aggregate flow between the parties over a time of interest is within a specified range of zero.

In block 385, the system may process subsequent transactions for those parties using a market price adjusted by the adjustment value specified by the parties.

The example flowchart of FIG. 3 has been offered for purposes of teaching only. Accordingly, some of these steps may be changed, rearranged, deleted, or replaced with other steps where appropriate. Such modifications may be based on particular disclosure needs or specific trading architectures and configurations, for example. Such derivations are within the teachings of the present invention.

It should be appreciated that various embodiments of the invention use some or all of the actions described in the blocks of FIG. 3. The actions that are performed in those blocks may be performed in the order listed, or in any other order.

FIGS. 4-5 depict exemplary bid-offer pairs according to at least one embodiment of the methods disclosed herein. In particular, FIGS. 4-5 depict an exemplary application of rules for determining a midpoint price from various bid-offer pairs.

FIGS. 4-5 show fifteen scenarios of bid-offer pairs for a particular market (e.g., a particular currency exchange such as U.S. dollars to Euros) that may be unexpired in the system at a time of interest, e.g., at a time of calculating a midpoint price for executing an order (such as 10:15 and 23.85 seconds). Each scenario may involve a different set of users and markets. In some embodiments, each pair may comprise an estimate of a fair bid price and a fair offer price for a particular currency exchange. Each pair may be received from a different user, e.g., over a network. As shown in the legend of FIGS. 4-5, various bid-offer pairs may comprise a regular spread (bid is greater than offer), inverted spread (bid is greater than offer), a rejected pair (indicated with an “x” mark). An “o” mark indicates a midpoint that may be determined for bid-offer pairs in the particular scenario. In each scenario, the x-axis may represent price, and the endpoints of each pair (e.g., arrowheads and dots) may represent bid prices and offer prices. For a double-headed arrow (e.g., representing a traditional non-inverted bid-offer pair), the offer is the right-most arrowhead (at the higher price) and the bid is the left-most arrowhead (at the lower price). Two non-inverted bid-offer pairs may be said to “overlap” if they cover at least one price in common (i.e., the line between the arrowheads of one arrow covers prices (i.e., points along the x-axis) that are also covered by the line between the arrowheads of another arrow.

According to some embodiments of the invention, the system may apply various rules to determine which bid-offer pairs may be used in a calculation of the market price. (In some embodiments, the market price may comprise a midpoint price.)

For example, in the scenarios of FIGS. 4-5, the system may reject each bid-offer pair that comprises an inverted spread. The system may also reject any un-paired bids and offers, i.e., bids (or offers) that do not have a corresponding unexpired offer (or unexpired bid) from the same user. (FIGS. 4-5 depicts only the paired bids and offers.) The system may also reject any pair that does not overlap with another pair, as described herein. For example, as shown in Scenarios 4 and 8, the system has rejected each bid-offer pair that does not overlap with any other pair.

In some embodiments, the system may determine the bid-offer pairs that otherwise remain eligible for use in calculating a midpoint price, e.g., after rejecting any expired, unpaired, or non-overlapping pairs. Of the remaining “otherwise eligible” bid-offer pairs, the system may apply an “overlapping” requirement. For example, the system may reject any “otherwise eligible” bid-offer pairs that do not overlap with at least half (e.g., 50%) of the remaining “otherwise eligible” bid-offer pairs (e.g., not counting the bid-offer pair at issue).

For example, in scenario 5, all four pairs may be “otherwise eligible” pairs. However, the system may reject the first pair (i.e., the left-most pair) because it overlaps only with the second pair and not the third or fourth pairs. Thus, the first pair overlaps with only one of the remaining three pairs (not including the first pair), which is only 33% of the remaining pairs. Similarly, the system may reject the fourth pair because it overlaps with only the third pair, and not the first and second pairs. The system may accept the second pair because it overlaps with the first and third pair, which is ⅔ of the remaining pairs (i.e., two thirds of the 2^{nd}, 3^{rd} and 4^{th} pairs). Similarly, the system may accept the third pair because it overlaps the second and fourth pairs. Accordingly, the system may determine that the second and third pairs are qualified for calculating a midpoint price. For purposes of discussion, these pairs that satisfy all the conditions for being considered in a midpoint calculation may be considered “sufficiently overlapping” or “qualified” pairs.

As shown in Scenario 5, the midpoint appears between the right-most arrowhead (i.e., offer price) of the second pair and the left-most arrowhead (i.e., bid price) of the third pair. The numerical price of the midpoint may comprise the average of the bid and offer prices of the second and third pairs.

As shown in Scenarios 7, 10, and 15, in some cases the system may determine that there are no qualifying or sufficiently overlapping bid-offer pairs. In some embodiments, the system may decline to determine a midpoint in such circumstances. In some embodiments, the system may deny, cancel, return, or otherwise decline to execute an order at a time when the system cannot (or does not or determines that it should not) calculate a market price.

It should be appreciated that the system may calculate a market price using any of a variety of algorithms. In some embodiments, the system may determine a market price that is equal to a midpoint price, in which the midpoint is calculated to be equal to a calculated average of the bids and offers of the “qualified” pairs. In some embodiments, the system may determine a midpoint price based further on a time. For example, the system may calculate a time-weighted average that weights each bid and offer value based on a time that the bid or offer was determined, submitted (e.g., by a user), or received.

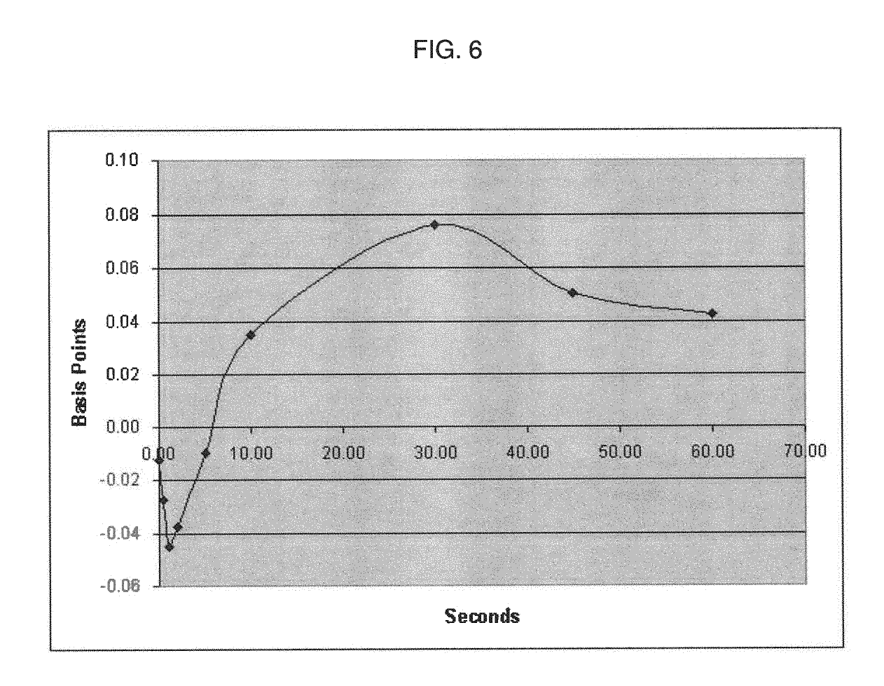

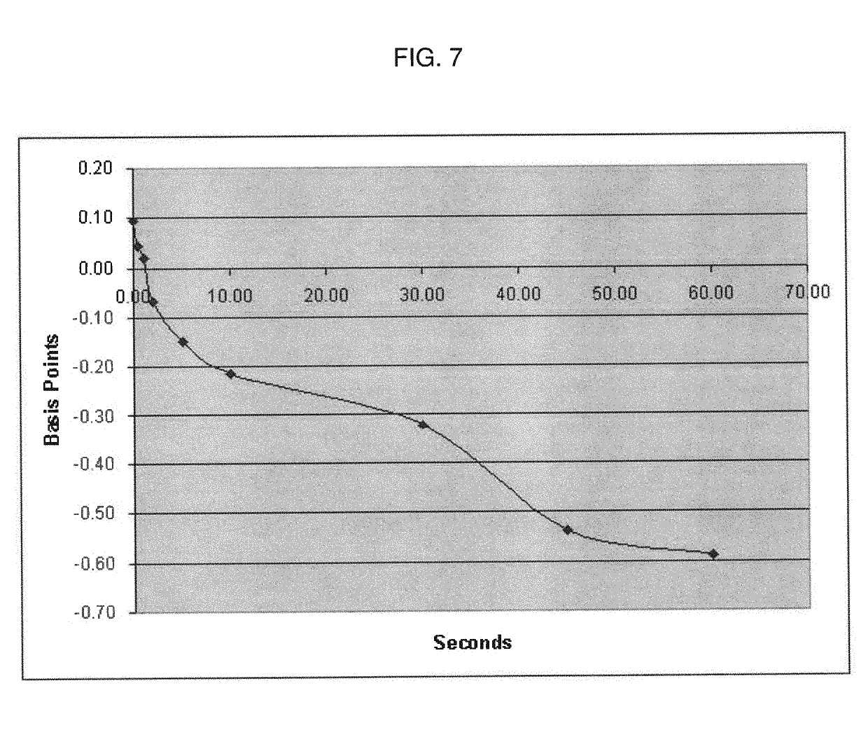

FIGS. 6-7 depict an exemplary graph showing changes in a market price over time according to at least one embodiment of the methods disclosed herein. The x-axis shows time in seconds, and the y-axis shows a price (as measured in number of basis points from a normalized “zero” value). In some embodiments, the y-axis may indicate price in pips, which may comprise a fractional amount of a basis point.

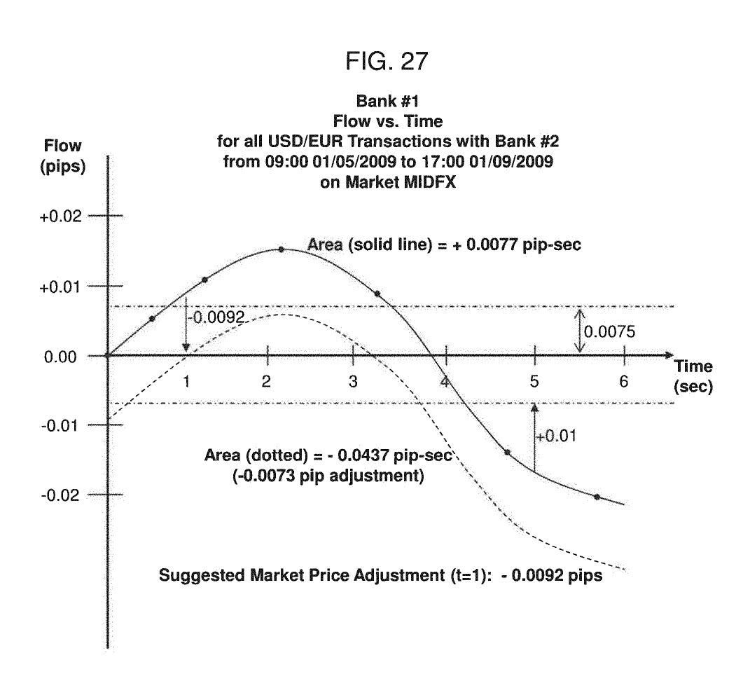

As described herein, “price flow” may refer to a change in price (e.g., market price) over time. The price flow may indicate an extent to which one party effectively “gained” or “lost” after executing a transaction, such as a purchase or sale of a product to another party. (For example, if a purchased asset rises in price, then the owner of the purchased asset effectively realizes a “gain” equal to the increase; and if a sold asset rises in price, then the prior owner of the asset failed to realize such gain.) FIGS. 6 and 7 show exemplary graphs of price flow over time starting at a particular time, such as a time of executing a transaction (e.g., executing an order to exchange one currency for another between two parties such as banks). Graphs showing price flow versus time are also described with respect to FIG. 27. Various principles described for FIGS. 6 and 7 may also apply to the principles described for FIG. 27, and vice versa, as relevant and applicable.

As shown in FIG. 6, a price (e.g., a market price such as a market exchange rate) at time t=0 may be normalized to zero for purposes of the graph. (These graphs focus on the change in price rather than the actual price.) The price may comprise a price of a single item (e.g., a market price of a security) or an aggregate price of a group of items (e.g., a weighted average market price of all items purchased from and/or sold to a specific party by another party). For instance, the price flow graph of FIG. 6 may show the change in price of all currencies purchased (and/or sold) by one bank from (and/or to) another bank. (It should be appreciated that price flow of purchases and sales would have to be adjusted so that disadvantageous movements in a purchase price (i.e., decreases in a price after purchase) do not counteract disadvantageous movements in a sale price (i.e., increases in a sale price after sale.)

After ten seconds, the graph shows that the market price has increased by about 0.037 basis points from its price at t=0. After 60 seconds (t=60), the price decreases to 0.042 basis points greater than the price at t=0. In one example, the graph of FIG. 6 may reflect the price of all dollars purchased by one bank in exchange for Euros from another bank in a particular day, or during a particular hour. The zero price may reflect the aggregate purchase price of those dollars at the time of purchase. (The total price of the purchased dollars may be $7,000,000, although it is normalized to 0.0 for purposes of the graph.) In some embodiments, all prices executed in the market may reflect a “market price.” Accordingly, $7,000,000 (or zero on the graph) may reflect the “market price” at t=0. As time increases the market price increases above $7,000,000, such that after 60 seconds the market price of the $7,000,000 is now 0.042 basis points above $7,000,000. Accordingly, the owner of the $7,000,000 realizes a 0.042 basis point increase in the market value of the purchased dollars. Accordingly, this graph shows a positive “price flow” for the purchaser of the dollars. A different graph showing the sale of the $7,000,000 from the perspective of the seller may indicate a corresponding negative “price flow.”

As shown in FIG. 7, a price (such as an exchange rate) starts at t=0 at 0.10 basis points greater than a normalized price (0.0 basis points). (For example, the normalized price may represent a market price, and the curve may show the current market price at time t. In some embodiments, the initial price (at t=0) may be zero, reflecting that the initial price is equal to the normalized price. In some embodiments, the value of the price at t=0 may be 0.10 basis points, or another value different from zero, to reflect that the price of the transaction has been adjusted, e.g., by an adjustment amount such as 0.10 basis points of the market price at t=0.) As shown in FIG. 7, after ten seconds, the price has decreased to 0.22 basis points below the zero price. After 60 seconds, the price has decreased further to 0.58 basis points below zero.

Although the price flow continues to change over time, e.g., as the market price for the product purchased or sold continues to change over time, a price flow may be determined for a particular transaction or plurality of transactions, e.g., a single transaction or multiple transactions between two users. For example, a measurement of the price flow may be determined to be the value of the price flow at a predetermined time after a transaction, such as 0.5, 1, 2, 5, 10, 15, 20, 30, 45, and 60 seconds after a transaction. In this scenario, it may be irrelevant how the price changed between the initial time and the final time of interest, as the initial and final times may be the only relevant times for purposes of determining flow.

Price flow may be measured or otherwise determined in any of a variety of different ways. In some embodiments, flow may be determined to be an integral of the flow graph during a period of time (e.g., during the first 0.5, 1, 2, 5, 10, 15, 20, 30, 45, or 60 seconds after a transaction), in which the initial price is zero. In this scenario, an increase in price above the transaction price during a first period of time may balance out a decrease in price below the transaction price during a second period of time.

Measurements of flow for one or more transactions (e.g., for one or more trades of a single product, trades with a particular party, trades on a particular exchange) may be aggregated in a variety of ways. For example, an aggregate measure of flow may aggregate the flow of individual transactions by weighting each transaction or flow measurement on the basis of time, quantity, transaction value (e.g., purchase price), current market value, counterparty, exchange, time of day, amount of time after the transaction, volatility measurement, transaction flow, or any financial condition discussed herein. For example, the flow of each transaction may be weighted according to transaction value (and/or current market value and/or quantity), such that the flow of a transaction whose transaction price was $5 million (or whose current market price is $5 million or whose quantity was 5 million units) may count more in the flow calculation, e.g., 5 times more or 2.5 times more, than the flow of a transaction whose transaction price was $1 million (or whose current market price is $5 million or whose quantity was 1 million units).

In some embodiments, a calculation of flow may comprise a straight average of all transaction flow amounts as measured at two seconds after the transaction, regardless of transaction value. As part of the aggregation, positive and negative values may be assigned to the flow for a particular party to indicate whether the flow had (or would have had) a positive or negative effect on that party. For example, a price increasing after a sale by one party and a price decreasing after a purchase by the same party may both be counted as negative flow amounts in an aggregation, as this may indicate that both had a negative effect on the party. Accordingly, the aggregate flow amount may provide an aggregate measure of whether the transactions at issue had a positive or negative effect on the party.

In some embodiments, the system may determine and output information such as price flow charts of FIGS. 6 and 7, and this information may be transmitted to one or more parties. In some embodiments, the information may be used to provide information about an adjustment in a market price between the two users so that aggregate flow between the parties is close to zero over time. Accordingly, if one user yielded high positive flow against another party during one day, the system may output the graphs and indicate a recommended adjustment in the market price for transactions between the parties in a second day. For example, the recommended adjustment may be an adjustment that, assuming a consistent volume of transactions between the two parties in the second day (and neutral net price flow), the price flow of all transactions between the two days would be close to zero. Thus, if the first user yielded a price flow of positive 0.01 basis points in the first day against a second party, the market price between the two parties may be adjusted in favor of the second party by 0.01 basis points for all transactions between the parties in the second day. (For example, the market price could be adjusted so that the second party buys from the first party at 0.01 basis points below the market price and sells to the first party at 0.01 basis points above the market price.)

In some embodiments, the system may provide to one or more users a user interface for configuring an adjustment amount. The system may store transaction data and market price data (e.g., a record of all bid-offer pairs received), so that the system can calculate a market price for any given time in the past, even if a market price was not actually determined at that time. Accordingly, the system may calculate the market price for a particular transaction and then track the relevant market price of that product over time. The system may aggregate the market prices of various transactions of a particular type, e.g., a type selected by one or more users (e.g., a type of currency exchange, and transactions with a particular party over a particular time period).

The user interface may enable users to view information such as price information and flow information (and information related to an adjustment amount or possible adjustment amount), select and/or configure the information to be viewed (e.g., by selecting appropriate icons at the interface), and select information relating to adjustment amounts (e.g., an adjustment amounts and/or possible adjustment amount).

The user interface may indicate one or more graphs showing the price flow of one or more transactions, e.g., all of the transactions between two parties (e.g., in a particular market, for a particular exchange) over a particular period of time (such as a day, week, etc.). In some embodiments, a numerical value may be provided that indicates a measurement of flow (e.g., a value representing an amount by which one or more prices of a corresponding one or more transactions has changed after the time of the respective transaction, e.g., as shown in FIGS. 6, 7, and 27).

In some embodiments, one or more users may wish to have substantially zero net flow between them over time so that neither has an advantage over the other in the long run. Such a system may encourage users to participate in the system, since the rules of the system may prohibit one party from yielding substantial market gains over another. In some embodiments, users may wish to participate in the system to buy and sell products (such as commodities or currencies) not to make a profit on those products directly, but to hedge a large short or long position in those products, e.g., in another market.

In some embodiments, the system or one or more users may use flow data to determine an amount to be paid by one or more parties to one or more other parties based on the flow data. For instance, the system may determine, based on the flow data, that one party has “benefitted” in market price transactions over another party (e.g., due to changes in the market price after the time of the transaction) by a specific amount. To prevent that party from “benefitting” over the long term, the “benefitting” party may pay a lump sum amount to the “disadvantaged” party in order to balance the “flow” of the transactions between them. The amount may be based on flow data for a specific time period, such as a day or a week, and this time period may correspond to the time (and frequency) of any payments between those parties. For instance, an amount corresponding to a “flow” imbalance between two parties for two weeks may correspond to an amount that is paid by a benefitting party to a disadvantaged party in order to balance the flow between those two parties for the relevant time period (e.g., two weeks). In some embodiments, such “rebalancing” to account for flow measurement disparities between parties may occur at various time periods, such as daily, weekly, or monthly, or any time such imbalance (e.g., a flow measurement between two specific users) exceeds a predetermine threshold, e.g., for a specific time period (such as for a specific day) or cumulatively (e.g., when a cumulative flow measurement exceeds a predetermined threshold).

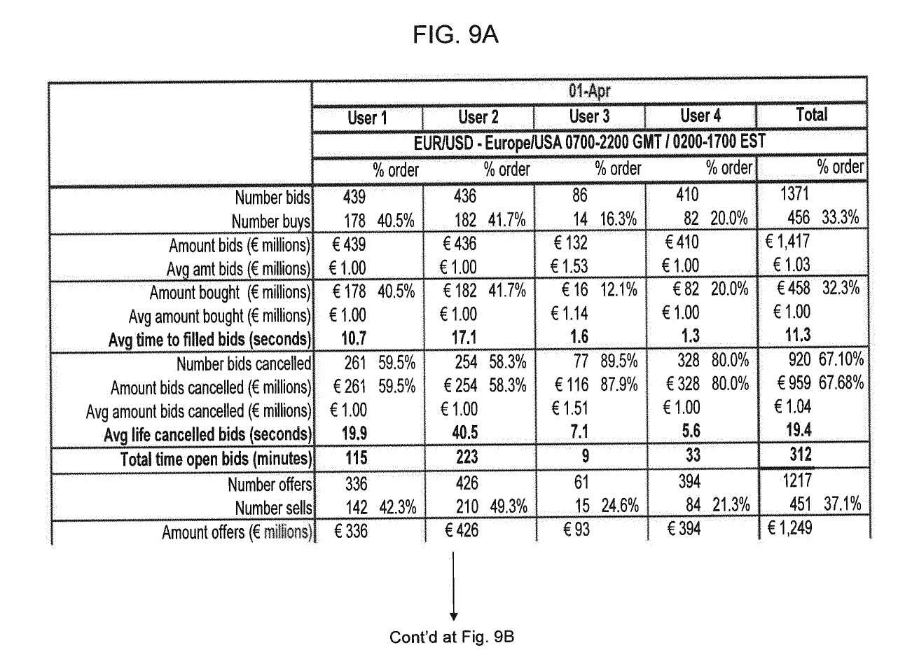

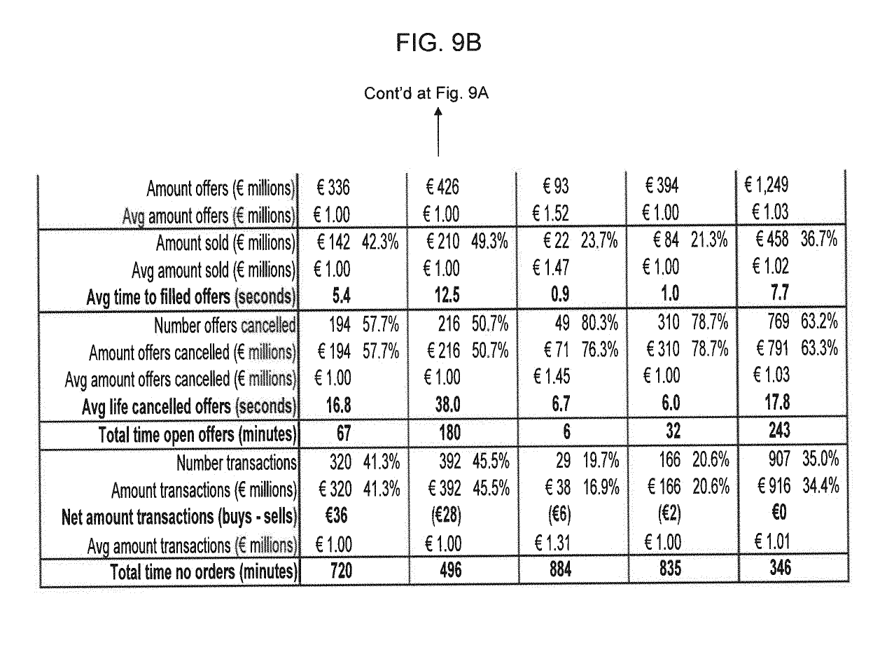

FIGS. 8A-9B depict exemplary tables showing trading information that may be determined according to at least one embodiment of the methods disclosed herein. For example, a plurality of users (e.g., users 1-4) may trade currencies with one another on an exchange such as server 2. The system may track information collectively and individually over a period of time (such as one day, e.g., April 1) for one or more currencies, e.g., in a particular market or exchange. The information may include such information as number of bids and offers; number of buys and sells; amount of bids and offers; amount purchased and sold; number of bids and offers cancelled; amount of bids and offers cancelled; average amount of bids and offers cancelled; total time bids or offers were open; number of transactions; amount of transactions; net amount of transactions (e.g., buys minus sells); total time no orders; and other information. FIGS. 8A-8B show such information for a Euro-dollar conversion for total transactions on the market. FIGS. 9A and 9B show such information for the Euro-dollar conversion at a particular time (7 am-5 pm GMT), e.g., on a London exchange.

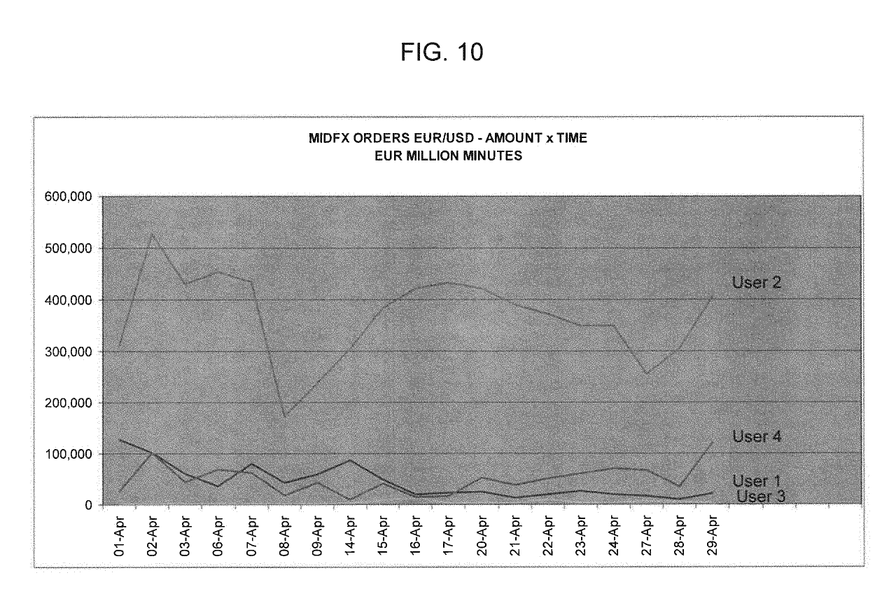

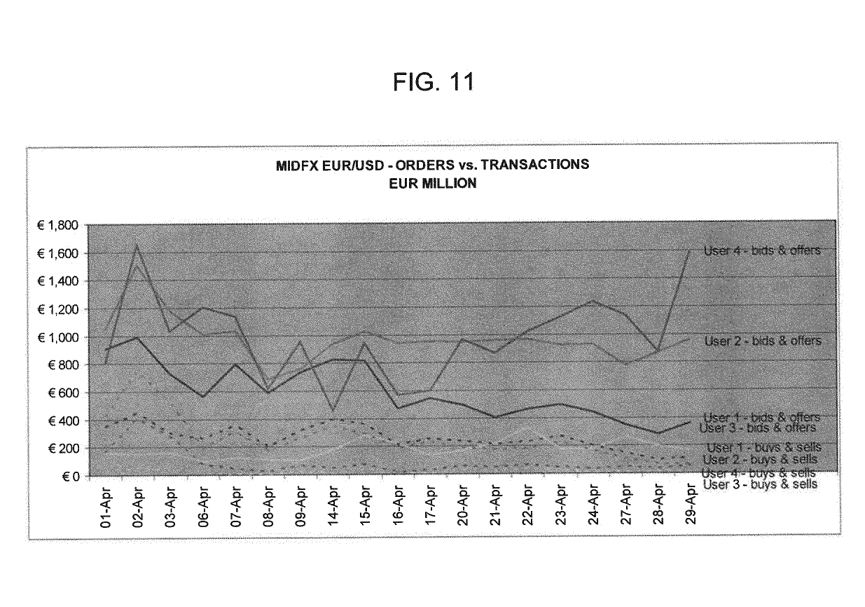

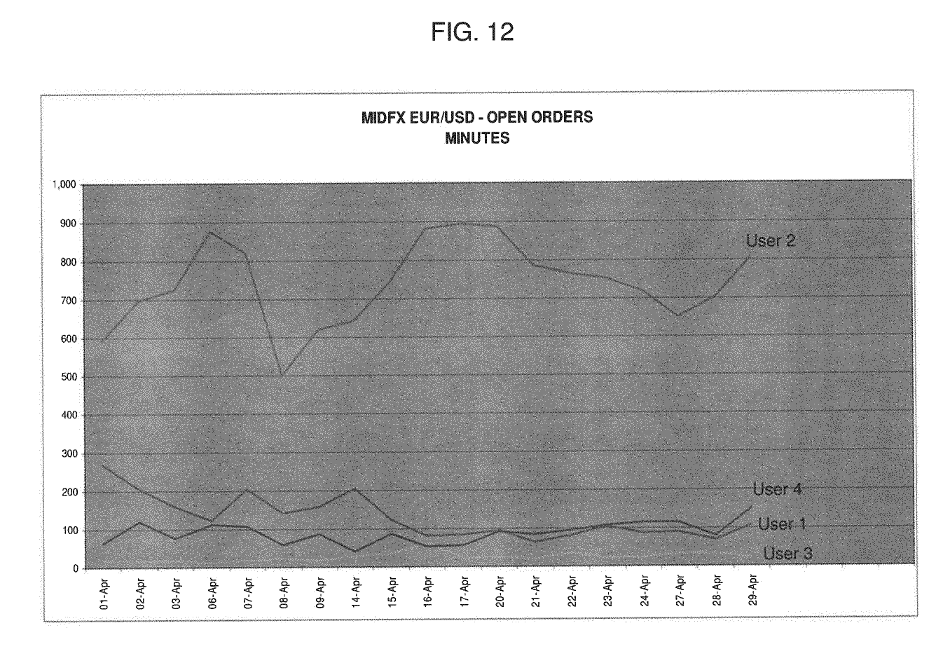

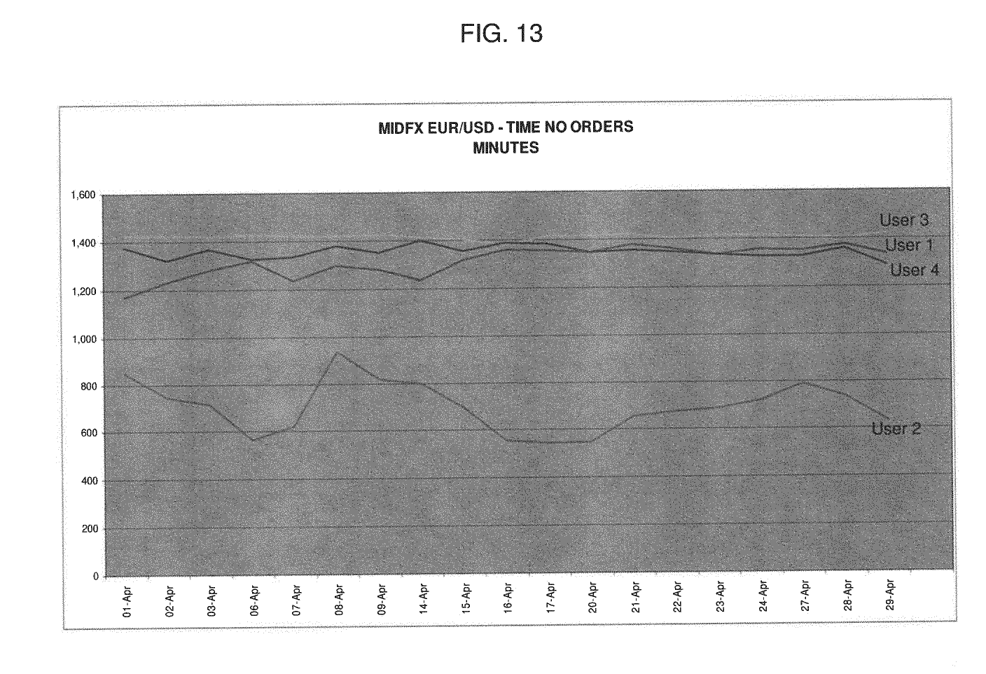

FIGS. 10-13 depict exemplary graphs showing trading information that may be determined according to at least one embodiment of the methods disclosed herein. In the specific embodiments shown in FIGS. 10-13, information about trades of a particular currency exchange (e.g., EURO/USD) among four different users of a currency exchange may be collected, processed, and output in graphs (e.g., and provided to users in a webpage). FIG. 10 shows a plot of an amount of orders times time (e.g., duration of the order) in the y-axis on a day by day basis (days in the x-axis). As shown in FIG. 10, user 2 had the highest value of orders times time each day. FIG. 11 shows the number of orders (solid lines) and the number of transactions (dotted lines) in the y-axis on a day by day basis (in the x-axis). Here, users 2 and 4 had the greatest number of bids and offers, while users 1 and 2 typically had the greatest number of buys and sells. FIG. 12 shows the number of open order minutes (y-axis) on a day-by-day basis (x-axis). Here, user 2 had by far the most open order minutes, meaning that user 2 tended to have more orders open for longer than the other users. FIG. 13 shows the amount of time (y-axis) per day (x-axis) that each user had no orders open. As shown here, user 2, who had the most open order minutes, also had the lowest incidence of no orders pending.

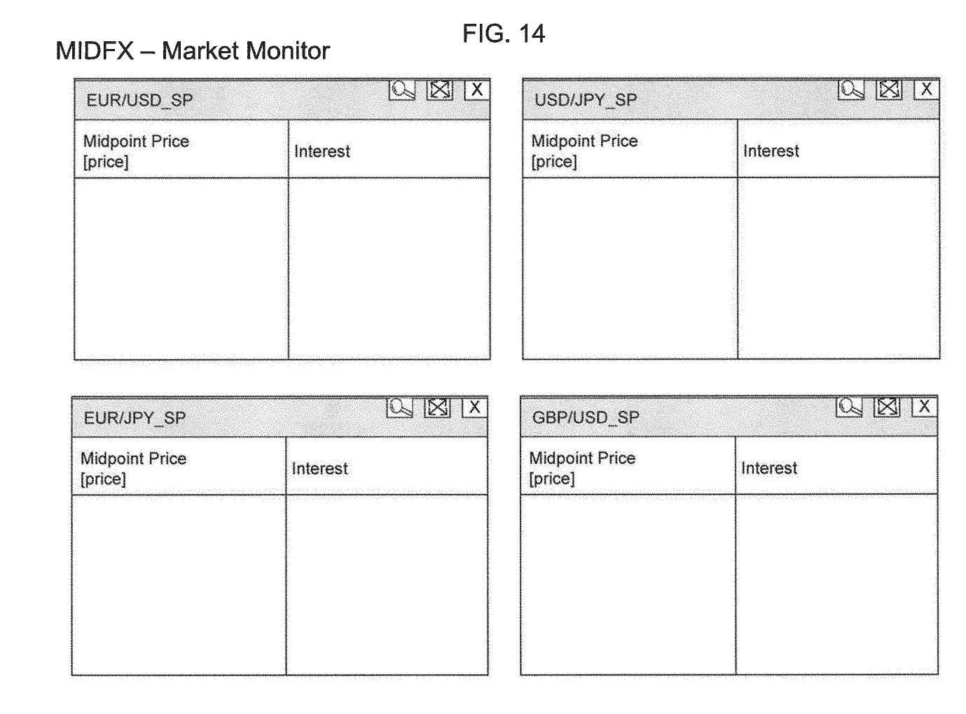

FIGS. 14-25 depict exemplary interfaces for managing and communicating order information according to at least one embodiment of the invention. The interfaces may comprise web pages or other computer applications that may be viewed by one or more administrators of the system.

In some embodiments, such user interfaces may be displayed to one or more users and/or one or more system administrators. In some embodiments, one or more users may also view one or more interfaces of FIGS. 14-25; in other embodiments the interfaces may be restricted to non-users, or may be time-restricted so that users may only view the interfaces after a particular transaction, order, bid, offer, or time period (such as at the end of a day or week).

The screens may be updated continually or continuously, e.g., in real time. Accordingly, in various embodiments, each screen comprise a snapshot of order and market information at a particular instant of time. In some embodiments, users may be precluded from viewing various order information.

As shown in FIG. 14, information about different exchange rates may be displayed in different windows.

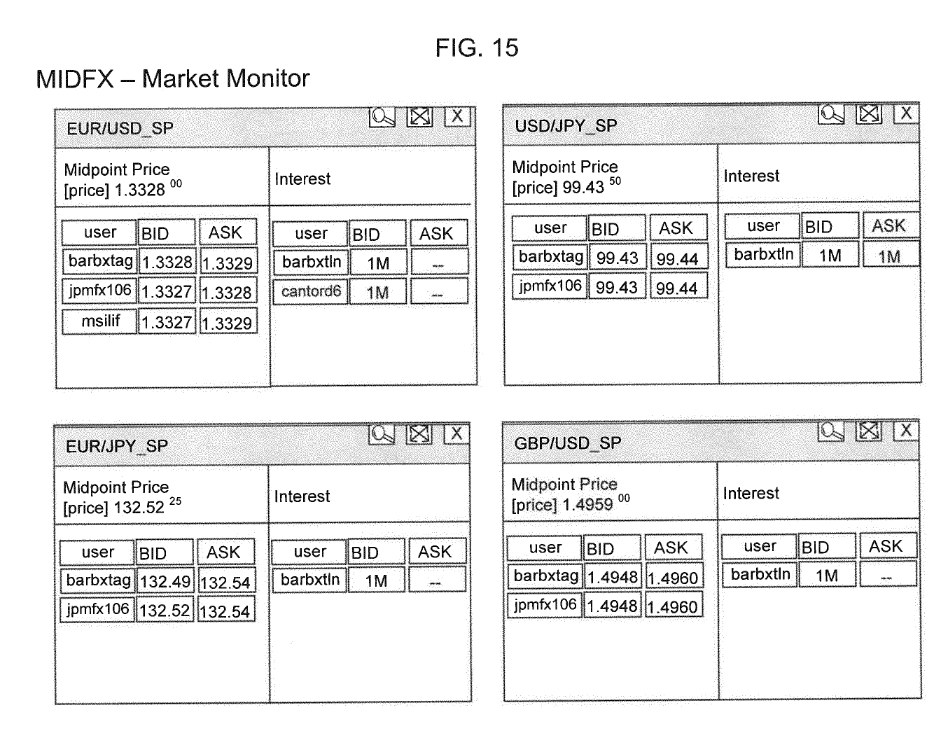

FIG. 15 shows various bid-offer pairs submitted by various users for a plurality of currency exchanges (each currency exchange having a separate window). In the left part of each window, the bid-offer pairs for each user may comprise the user's assessment of a fair bid price and a fair offer price at a particular time. As shown in the left side of each window, a midpoint price may be calculated for each currency exchange, e.g., as described herein (such as by a straight average of all currently valid bids and offers of the valid bid-offer pairs for that currency exchange). The midpoint price may comprise the market price at which orders will be executed at the particular instant in time. As shown in the right side of each window, the “interest” section may show any active bids and offers, each bid and offer specifying a quantity.

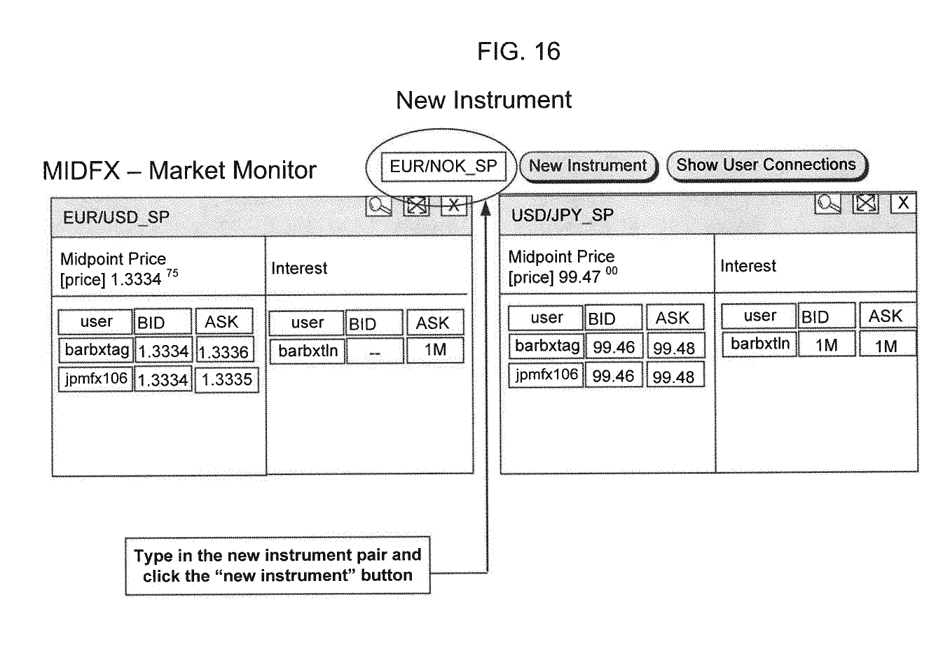

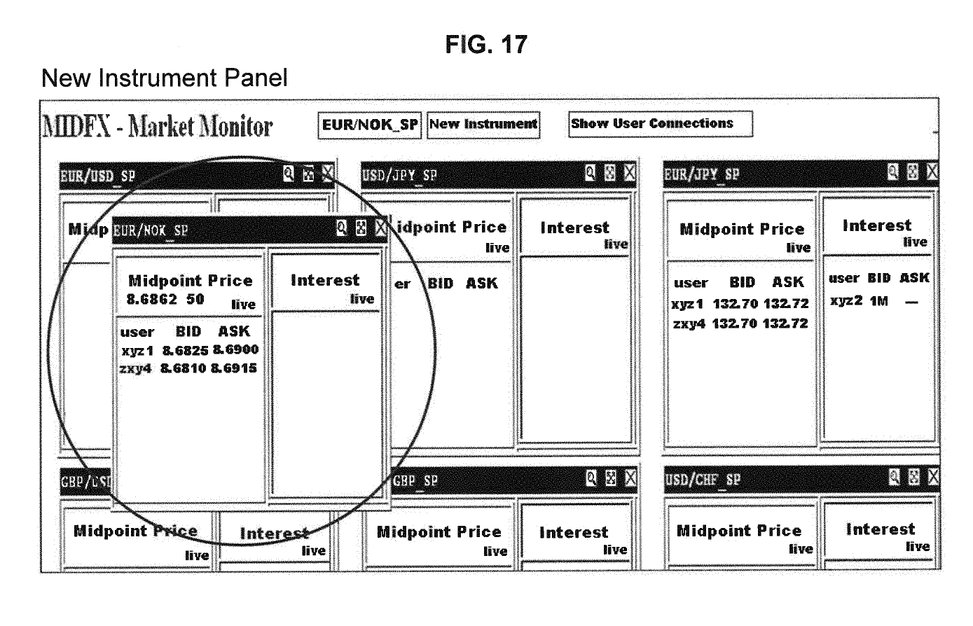

As shown in FIG. 16, a user of the system (or system admin) may type in or select a new instrument, such as a financial instrument such as a currency conversion pair. As shown in FIG. 17, bid-offer pairs and calculated midpoints may be shown for the selected instrument.

As shown in FIG. 17, a “user overview” window may show information about each user, e.g., each user's connection to the system. In some embodiments, if a user's connection to the system is disrupted (e.g., the user is disconnected), then the user's orders and bid-offer pairs may become immediately invalid and withdrawn.

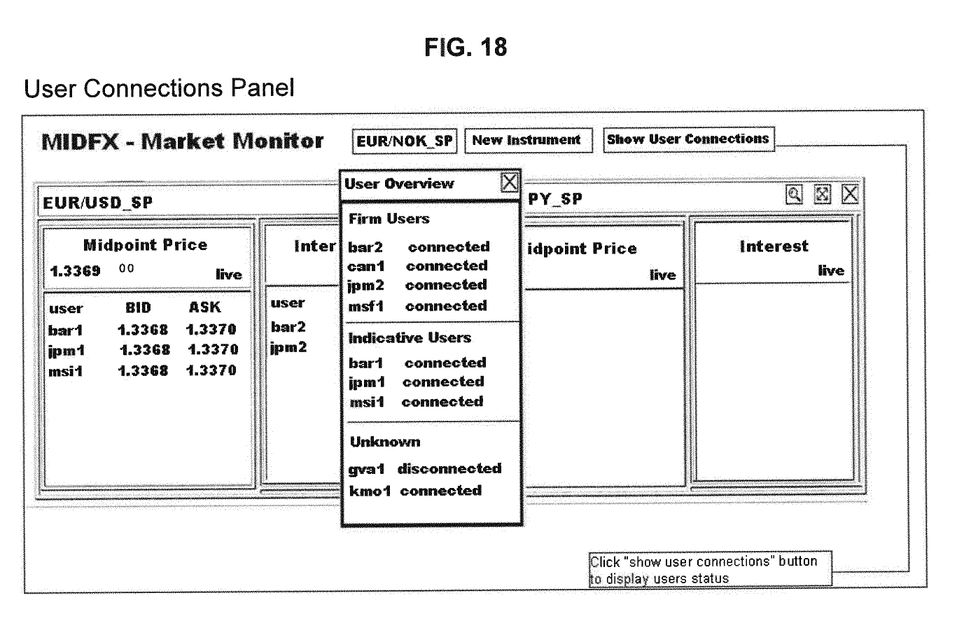

As shown in FIG. 18, each window may be maximized to show more information about the instrument, such as trade history. The trade history may show a transaction id for each trade, the time of the trade, the price (e.g., determined midpoint price) at which the trade executed, the quantity traded, and the identity of the buyer and seller. In some embodiments, the buyer and seller may remain anonymous, at least until the transaction is completed. In some embodiments, users may be provided transaction information (e.g., identities of buyers and sellers) only on an aggregate basis, e.g., such as the information shown in FIGS. 8-9 and FIGS. 10-13.

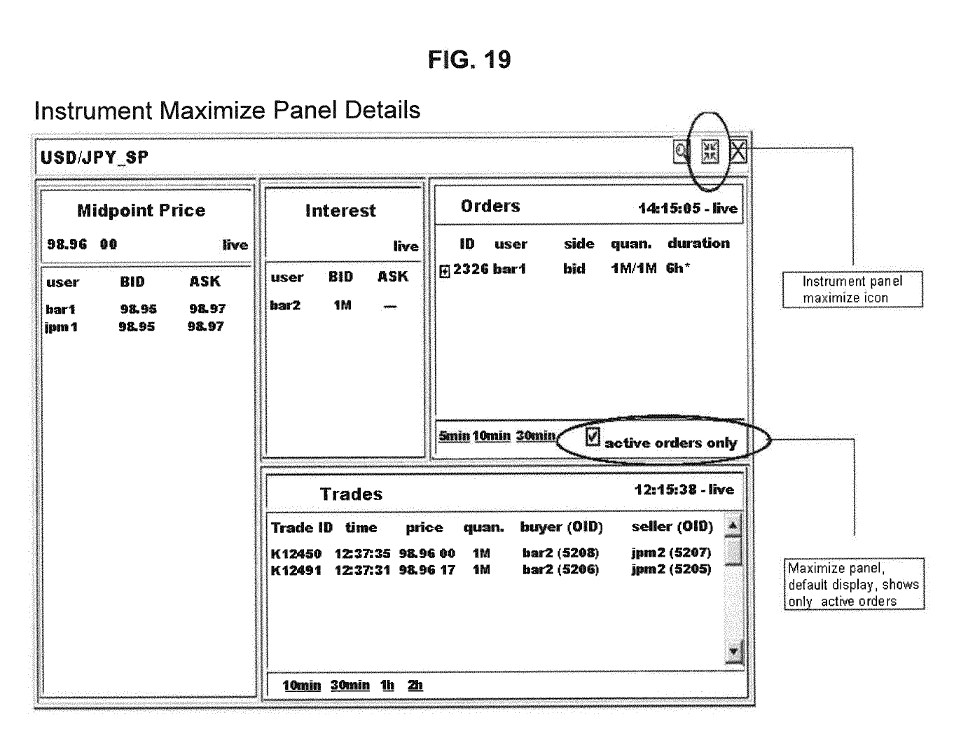

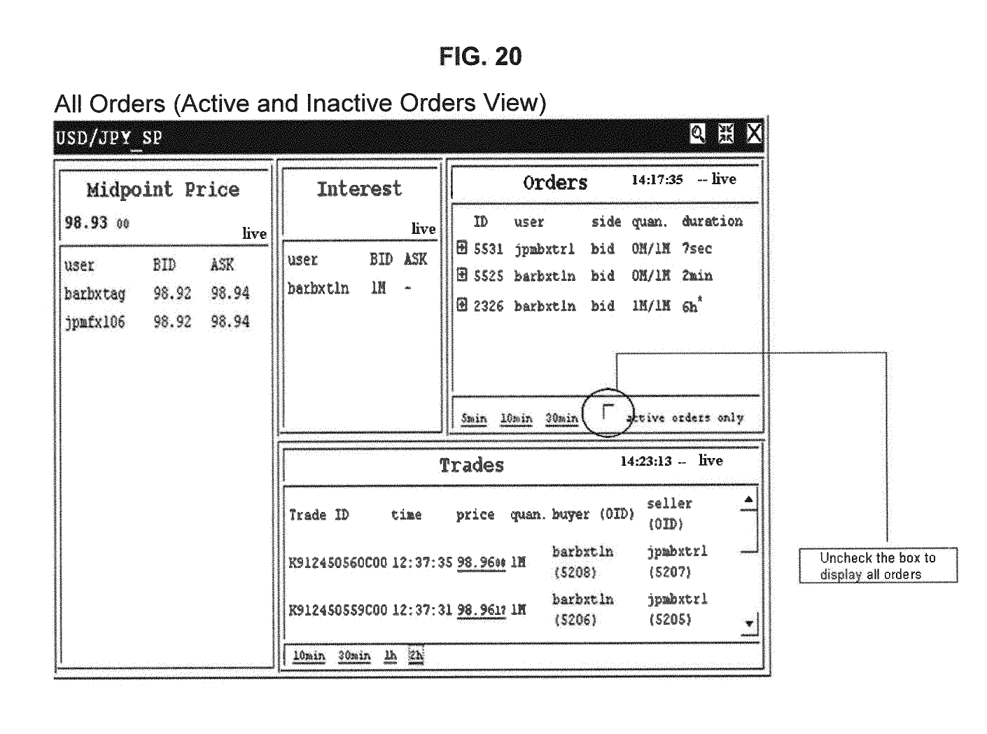

As shown in FIGS. 19-20, additional detail about active orders (FIG. 19) and/or all orders (FIG. 20) may be provided. The information may include the quantity of the order, the user who submitted the order, and the duration of the order (e.g., time specified by the user for the order to be open, or in some embodiments the remaining time until the order expires).

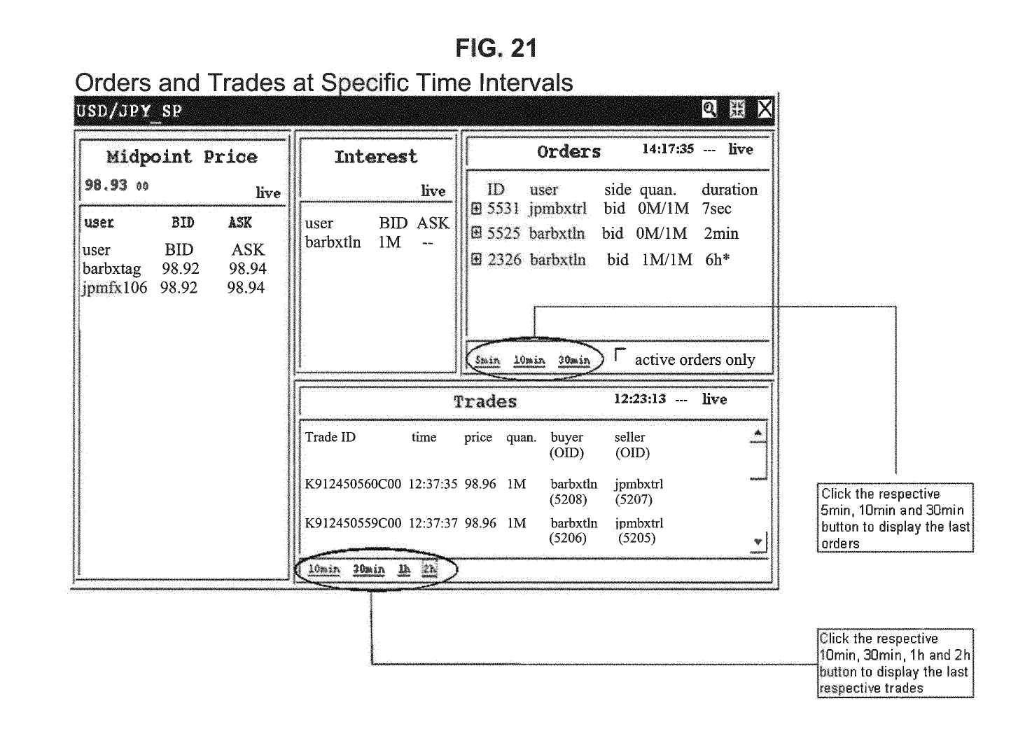

As shown in FIG. 21, additional information about trades and orders may be displayed according to specific time intervals such as 5, 10, and 30 minutes.

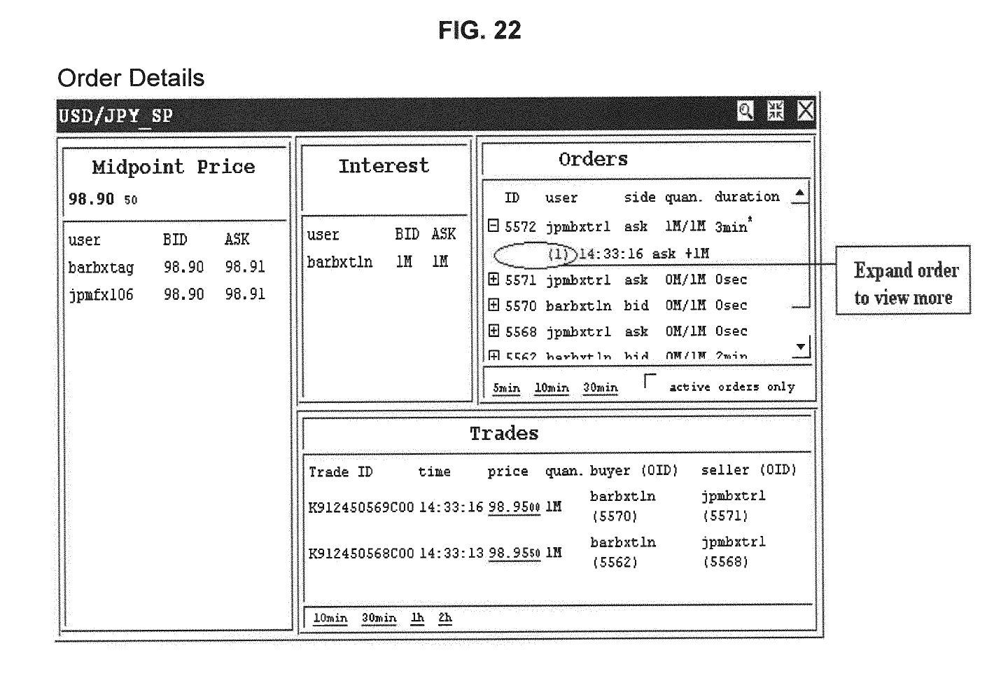

As shown in FIG. 22, orders may be selected to cause the display of additional information about the order (or trade), such as the time of submission.

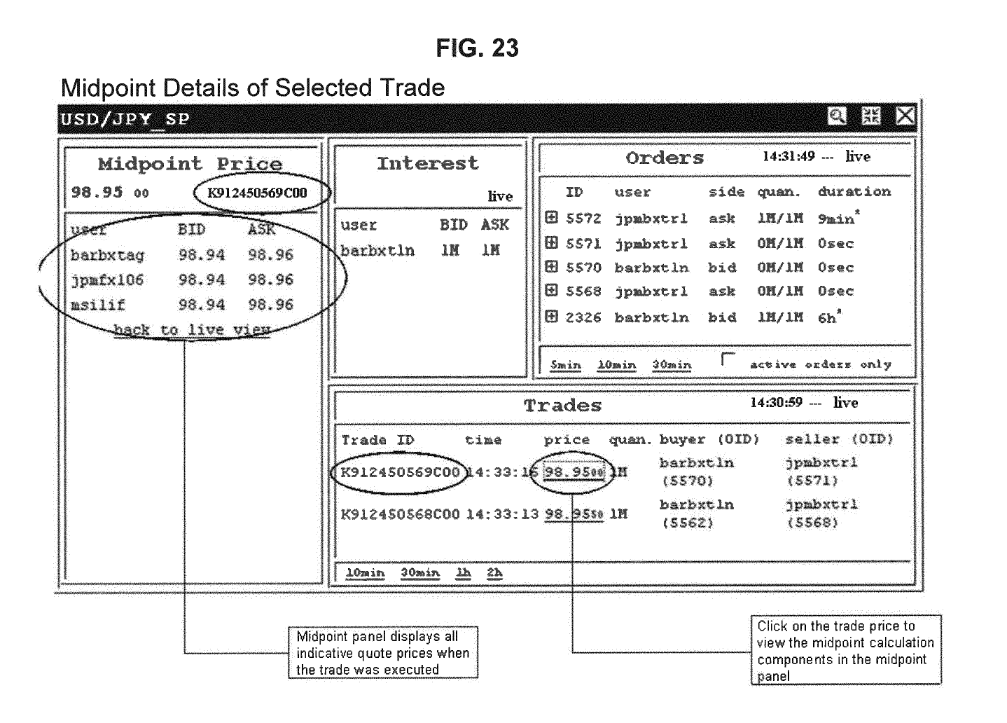

As shown in FIG. 23, order prices (e.g., market prices, such as market prices determined according to a midpoint) may be selected to cause the display of additional information about the midpoint price. For example, the interface may display the components (e.g., bid-offer pairs) that went into the calculation of the midpoint price.

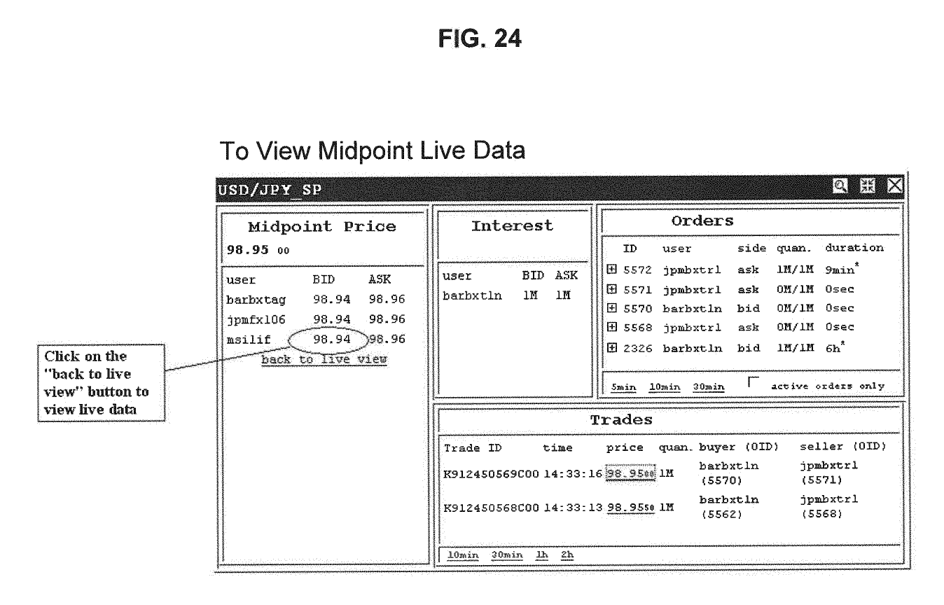

As shown in FIG. 24, market prices (e.g., midpoint prices) may be viewed in real time or historically.

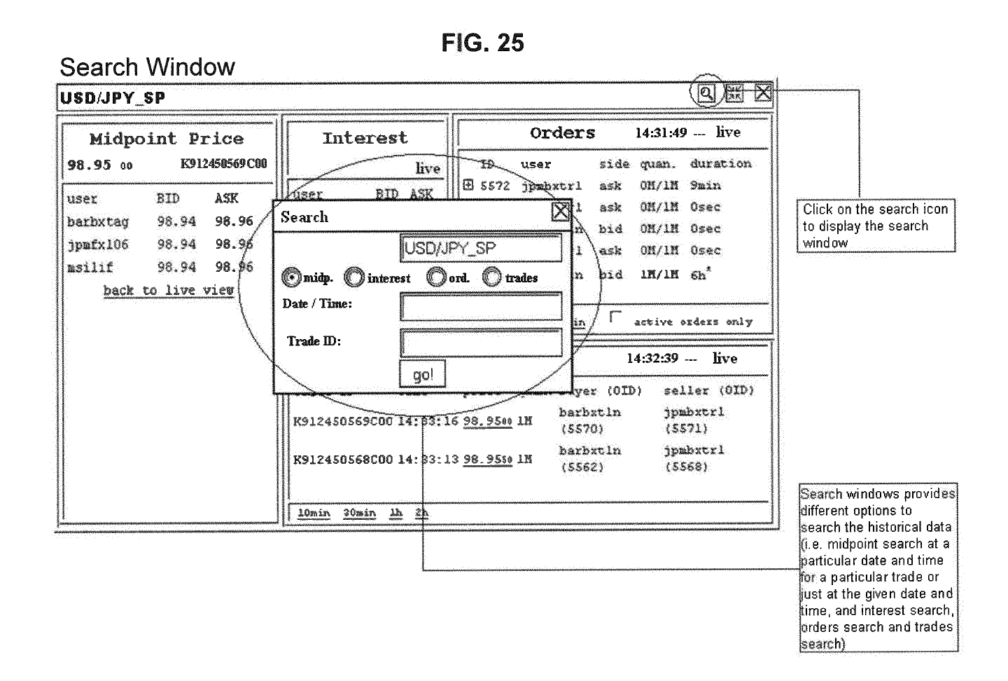

As shown in FIG. 25, market, order, and trade information may be searched. For example, a search for a particular product (e.g., a specific currency conversion) may cause the interface to display historical data associated with orders and trades for the product by users.

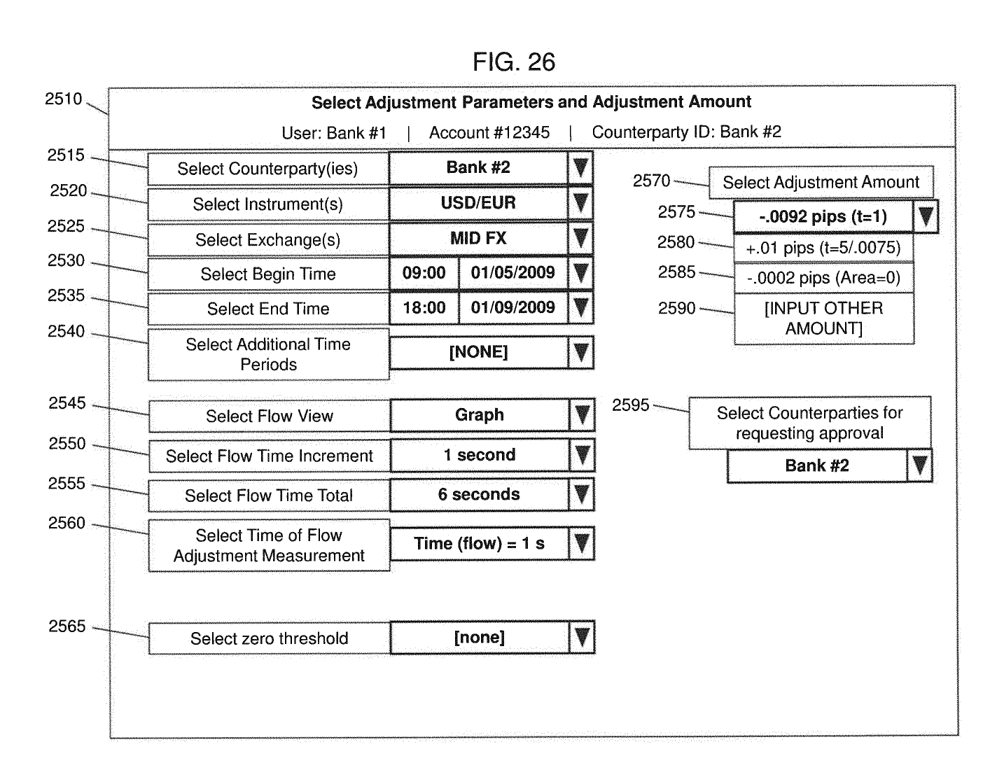

FIG. 26 depicts an exemplary interface for configuring price adjustment information according to at least one embodiment of the invention. The interface of FIG. 26 may comprise an interface for a user or administrator of system. The interface may be output to one or more users of system, e.g., for viewing and/or selecting an adjustment amount, e.g., for one or more transactions with one or more counterparty users (e.g., for one or more types of trades with such counterparty).

As shown in FIG. 26, a user identification area 2510 may comprise indicia that indicates a user identity (e.g., “Bank #1”), an account number of the user (e.g., “12345”), a counterparty identifier (e.g., “Bank #2”), and other information. User identification area 2510 may also indicate other information about a user, and may indicate that a user may adjust parameters and amounts (e.g., adjustment amounts) in the interface.

In some embodiments, a single adjustment amount may be determined for a one or more different time periods, one or more different counterparties,

Various areas, e.g., areas 2515-2545, may comprise windows having selection areas and/or drop-down menus, e.g., for selecting various criteria related to an adjustment amount, such as an adjustment amount display or a adjustment amount that may be selected by one or more users or a system. (In some embodiments, the drop-down menus may be triggered by selectable drop-down icons comprising a downward-pointing solid triangle, e.g., to the right of the boxes in bold. Drop-down menus may cause the interface to display one or more selectable options, e.g., options of the same type as that associated with the area immediately to the left of the drop-down icon.) Select counterparty area 2515 may comprise an indicia for selecting one or more counterparties, such as Bank #2 (or Bank #3, or any other user, e.g., of a particular market). Select instrument area 2520 may comprise an indicia for selecting one or more products (e.g., financial instruments such as one or more currency exchanges, e.g., USD/EUR and USD/AUD). Select Exchange area 2525 may comprise an indicia for selecting one or more exchanges, e.g., if the relevant user (e.g., Bank #1) trades on a plurality of different exchanges, such as the New York Stock Exchange, the Chicago Mercantile Exchange, and/or an exchange called MIDFX operated by eSpeed, Inc., BGC Partners, Inc., and/or their affiliates.

Select begin time area 2530 and select end time area 2535 may comprise an area for selecting the beginning and ending times of a period for which price flow may be measured (e.g., the first full workweek in 2009). Select additional time periods area 2540 may enable users to select additional time periods for which flow may be measured, e.g., in a single graph or metric. Accordingly, the interface of FIG. 26 may enable users to select and view flow information related to a plurality of different and non-contiguous time periods at the same time, e.g., in a single graph.

In some embodiments, the system may enable users to configure adjustment graph and amount settings on the interface of FIG. 26. In some embodiments, flow and adjustment amount information may be output, e.g., in the user interface of FIG. 27. For example, select flow view area 2545 may enable users to select a type of display of flow information, such as a graph (e.g., showing flow for a selected period of time), table (e.g., showing flow at various times after a transaction), numeric amount (e.g., a single flow amount representing flow), continuously updated graph in real time (e.g., showing changes in flow in real time), multiple graphs (e.g., one graph for each transaction, type of transaction, counterparty, time duration, or other factor described herein), or other manner of outputting information. Select flow time increment area 2550 may enable users to select a time increment (such as 0.1 seconds, 0.5 seconds, 1 second, 2 seconds, etc.) for use as a scale of a graph at an interface (e.g., the graph at the interface of FIG. 27). Select flow time total area 2555 may enable users to select a total time shown on a user interface (such as that of FIG. 27). For example, a user may select that a graph should show the first six seconds of flow after a transaction time.

Select time of flow adjustment measurement area 2560 may enable users to select a specific time at which a flow or adjustment value may be measured or determined. For example, the system may measure flow at this time value, and such measurement may be used in the system's determination of an adjustment amount. For example, a user may select one second, and the system may determine the flow measurement at t=1 second after a transaction (or plurality of transactions).

Select zero threshold area 2565 may enable a user to select a threshold maximum acceptable flow amount. For example, the selected amount may be an amount that is close enough to zero (in either the positive or negative direction) that the price flow may be considered to be de minimus. For example, two parties may agree that it is not necessary to determine an adjustment amount (or an adjustment amount may be determined to be zero) if a flow measurement (e.g., a value of flow at a particular time, a weighted average of flows at different times, an integral of a flow curve, or other flow measurement) is within a particular threshold from zero.

Select adjustment amount area 2570 may enable users to select an adjustment amount. For example, the system may measure price flow according to various preferences, e.g., as specified or otherwise selected by user (e.g., using selections described with respect to FIG. 26 or otherwise described herein). For example, the system may output a graph (e.g., the graph shown in FIG. 27) that shows flow versus time for all of Bank #1's EUR/USD transactions with Bank #2 on a “MID FX” exchange that occurred from 9 am on Jan. 5, 2009 to 5 pm on Jan. 9, 2009. The graph may show the cumulative flow of the transactions using a graph having a scale of 1 second time increments for a total of six seconds (i.e., after the time of transaction). The amount of flow may be calculated so that positive flow values correspond to positive effects on Bank #1's financial position with respect to the transactions at issue and negative values correspond to negative effects on Bank #1's financial position with respect to the transactions at issue.

The system may prompt users to select one of several calculated possible adjustment amounts in areas 2575, 2580, 2585, or to input another amount in area 2590 (e.g., an amount of the user's choosing such as 0.01 pips). Calculated possible adjustment amounts 2575, 2580, 2585 may represent possible adjustment amounts based on various adjustment criteria such as one or more flow measurements, historical data concerning one or more transactions between and/or among two or more parties, and other criteria. A user may select an adjustment amount (and make any other selections at any of the user interfaces) by clicking on (e.g., using a mouse) or otherwise selecting the corresponding icon. For example, each of the items in bold in FIG. 26 may indicate that a user has selected that item.

For example, amount 2575 may represent an amount by which the original market price (e.g., 0 at t=0) differs from a value of the market price (e.g., the value of the market price at a particular time, an aggregation such as an average of the value of the market price at a plurality of different times, or another measure). As shown in FIG. 27, amount 2575 shows the amount by which the original market price (0) differs from the price at a time selected by the user in select time flow increment area 2560 (i.e., t=1 sec). The value of flow at t=1 may be 0.0092 pips, so the value of amount 2575 may be −0.0092 pips. This amount may reflect the amount by which the curve would need to be adjusted upward or downward in order to equal zero at the respective time. As a particular time. In some embodiments, amount 2575 may represent an amount by which the market price would need to be adjusted at a time selected by the user (here, the user may have selected t=1 sec at area 2560) in order for the flow at that time (t=1) to be zero. As shown in FIG. 27, if the flow curve is adjusted downward by −0.0092 pips, then the adjusted market price (market price minus 0.0092 pips) would be equal to zero at t=1 second. Accordingly, area 2575 may indicate an amount by which the transactions at issue in FIG. 27 could have been adjusted to cause the solid curve in FIG. 27 to be zero at a particular time (e.g., t=1 second).

In some embodiments, parties such as banks may not require a value of flow to be zero, but rather to be within a maximum threshold of zero. Accordingly, in some embodiments, the system may suggest adjustment amounts that would yield a flow that is within a predetermined or user-selected threshold of zero (e.g., 0.0075 pips of zero, as shown in the dotted lines above and below zero in FIG. 27). For example, calculated possible adjustment amount in area 2580 may comprise an amount by which the market price at a particular time (e.g., t=5 seconds) differs from a threshold of zero (e.g., +/−0.0075 pips). For example, as shown in area 2580, the system may determine that the current market price at t=5 seconds needs to be adjusted by +0.01 pips in order to be within 0.0075 pips of zero (e.g., as shown in FIG. 27). Put another way, had the transactions at issue in the graph of FIG. 27 been adjusted to be more favorable to Bank #1 by 0.01 pips, then the market price at time t=5 seconds would have been −0.0075 pips, which is within 0.0075 pips of zero.

Calculated possible adjustment amount in area 2585 may comprise an adjustment amount that would have caused the area under the flow curve to be zero (or within a predetermined threshold of zero) over a predetermined period of time, such as the time scale of the graph. For example, the system may determine that if the price (e.g., of the relevant transactions at issue in the graph of FIG. 27) had been adjusted in favor of Bank #2 (and against Bank #1) by an amount of 0.0002 pips (e.g., as rounded to the nearest fourth decimal of a pip), then the area under the solid flow curve shown in FIG. 27 (e.g., for a time of the six seconds shown in the graph) would be zero. In some embodiments, the area 2585 may comprise an amount that would have adjusted the area to within a threshold of zero, e.g., within an area equal to a minimum pip threshold (e.g., 0.0075 pips) times the relevant time period for which the area is calculated (e.g., 6 seconds).

It should be appreciated that the system may determine possible adjustment amounts in any of a variety of ways. For example, the system may apply any of the algorithms discussed herein to determine an adjustment amount. In some embodiments, system may calculate an adjustment amount based on several factors such as the area under the curve for a particular time period, the value of flow at a particular time (or times), and predetermined or otherwise configured (e.g., user-selected) minimum thresholds. For example, the system may determine a suggested adjustment amount based on an average of one or more of the possible adjustment values calculated in any manner described herein (e.g., an average of adjustment amounts calculated at each of 1 second, 2 seconds, 3 seconds, 4 seconds, 5 seconds, 6 seconds, and the adjustment amount needed to cause the area under the curve of FIG. 27 to be zero).

For example, the system may determine the amount by which the curve should be displaced (up or down) to cause the integral of the displaced curve to be zero or within a predetermined and/or user-selected threshold of zero.

Area 2595 may comprise an icon for selecting one or more entities such as counterparties from which approval may be requested (e.g., by a user, the system or another entity). For example, a user may configure an adjustment amount for transactions with one or more counterparties, and area 2595 may enable the user to request approval of that configured adjustment amount from one or more of the counterparties. As shown in FIG. 26, the counterparty of Bank #1 for the transactions at issue in FIG. 26 may be Bank #2; accordingly, as shown in FIG. 26, the user (Bank #1) may request “Bank #2” to approve a configured adjustment amount (e.g., −0.0092 pips). In some embodiments, a user may request that multiple different users approve a configured adjustment amount.

In some embodiments, different users may select different adjustment amounts, and the different users may communicate with one another to agree upon on one or more adjustment amounts. For example, one user may propose an adjustment amount and request approval from another user. The other user may approve the adjustment amount, reject the adjustment amount, or propose a different adjustment amount (e.g., and request approval from the first user, and the approval process may continue any number of times until the parties agree on an adjustment amount).

FIG. 27 depicts an exemplary interface for configuring a price adjustment amount according to at least one embodiment of the invention. FIG. 27 comprises two curves in a graph of flow versus time, one solid curve and one dotted curve. The solid curve may be a “best fit” curve generated from several measured data points, e.g., several determined market prices (indicated by the solid dots on the graph).

In some embodiments, the curves shown in FIG. 27 may correspond to the interface of FIG. 26, and may comprise a graph of flow versus time, e.g., as specified in the interface of FIG. 26. As shown in FIG. 27, the solid line graph may represent a graph of flow versus time showing an aggregate measure of price flow versus time based on selections made in the interface screen of FIG. 26, e.g., counterparty, instrument, exchange, begin time, end time, flow view, and other parameters (such as those shown in FIG. 26).

Accordingly, the solid line graph of FIG. 27 may show the change in market price (e.g., flow) at time t after a transaction (or a plurality of transactions, e.g., trades). In some embodiments such as the embodiment of FIG. 27, each transaction may be executed at a current market price (e.g., a price in effect at the time of the transaction, e.g., a price determined at or substantially at the time of the transaction, e.g., immediately prior to the transaction). Accordingly, the “initial flow” value at t=0 (i.e., the time of the transaction) may be the market price at t=0. Since the flow of FIG. 27 is measured as a change from the initial market price at t=0, the price at t=0 is shown to be zero (in units of pips away from the original market price). For example, if the initial price is $100, then the price at t=0 is $100 or zero pips (i.e., zero pips away from $100). As the market price changes over time, the price may deviate from the “zero” price of $100, and the deviation may be measured in pips.

The flow may be aggregated, e.g., for a plurality of transactions that satisfy the criteria specified in the interface of FIG. 26, according to any of the methods described herein. As shown in FIG. 27, the aggregate market price of the selected transactions starts at 0 pips at t=0. As indicated in FIG. 27, at approximately 2.2 seconds after the time of the transaction, the aggregate market price has increased to approximately 0.015 pips, and the price increases further to approximately 0.015 pips at t=2.2 seconds. The price then drops to about 0.095 at about t=3.25 seconds, and continues to drop to about −0.0145 at t=4.7 seconds and further drops to about −0.021 at t=5.7 seconds.

As shown in FIG. 27, the curve intersects 0 pips at approximately t=3.75 seconds. Although the flow was not measured to be 0 pips at any point before t=6 seconds (other than t=0 seconds), a user may infer that the effective market price crossed zero pips (i.e., returned to the original starting market price) sometime between t=3.25 seconds and t=4.7 seconds.

As shown in FIG. 27, the dotted line may represent a graph of flow similar to the dotted line that is adjusted by an adjustment amount, e.g., a recommended or suggested adjustment amount. Accordingly, the dotted line shows what the flow would have looked like if each of the transactions at issue had been adjusted by an adjustment amount. The arrow may show the direction in which the graph is adjusted from the actual historical graph. The number “−0.0092” next to the arrow may indicate the adjustment amount (e.g., −0.0092 pips); here, the dotted graph has been adjusted from the line graph by the adjustment amount. In some embodiments, the graph may comprise a “best fit” curve of measured data points. For example, the dots on the solid curve may represent actual measurements (e.g., measurements made at a time when a state or variable changed, such as a the market price is recalculated, a new bid or offer is received, etc.).

In some embodiments, a user may generate a dotted line graph, e.g., by selecting the line graph and moving the graph upwards or downwards. For example, the amount of movement in the up and down direction (y-axis) may represent an adjustment amount selectable by the user. For example, the user may select an adjustment amount by moving the curve up or down by an amount, wherein the amount of movement (in the y-axis) is the selected adjustment amount. In some embodiments, the system may determine the integral of the curve (e.g., the area underneath the curve) up to a specified time, e.g., six seconds. The system may automatically calculate the area underneath the original (solid) curve; here, the system may calculate this value to be +0.0076 pip-seconds. The system may also calculate the area under the dotted curve as the dotted curve is moving. For example, in the current displaced position, the area under the dotted curve (e.g., from zero to six seconds) may be −0.0437 pip-seconds, reflecting a net adjustment in the negative direction.

In some embodiments, the interface may show a minimum or maximum flow threshold. For example, the horizontal dotted lines at +/−0.0075 pips may show the values of these thresholds on the interface of FIG. 27. The threshold may be determined by the system or selected by the user (e.g., at select zero threshold area 2565, wherein a user may input a value or select a suggested or default value). In some embodiments, the system may determine an adjustment amount that would be necessary to adjust a particular measurement of flow (e.g., a measurement at a particular time specified by the system or selected by a user, an average measure, or another measure described herein) so that the flow as adjusted by the adjustment amount would cause the flow measurement to be within the threshold levels. For example, two parties might agree that as long as the flow between them in a given day is within 0.0075 pips (or another amount) of zero as measured at a specific time (e.g., 1 second after the transaction(s)), then there is no need to adjust the market price for transactions in a following day. The parties may also agree that if the flow is not within the threshold amount (e.g., 0.0075 pips), then the adjustment amount should be set to an amount that would have caused the flow to be within such tolerance (or another designated tolerance, such as 0.0025 pips).

In some embodiments, the system may calculate an adjustment amount that would yield a curve having an area that satisfies one or more criteria. For example, the system may calculate an adjustment amount that, when added to the curve (to displace the curve by the adjustment amount), would yield an area of zero, or an area that is within a predetermined or user-selectable threshold of zero (such as 0.0001 pip-seconds), e.g., for a predetermined or user-selectable time period such as six seconds. In some embodiments, the area may represent an integral across the time period of interest for a best fit curve based on the data points (represented as dots), in which the best fit curve is a best-fit polynomial function of time.

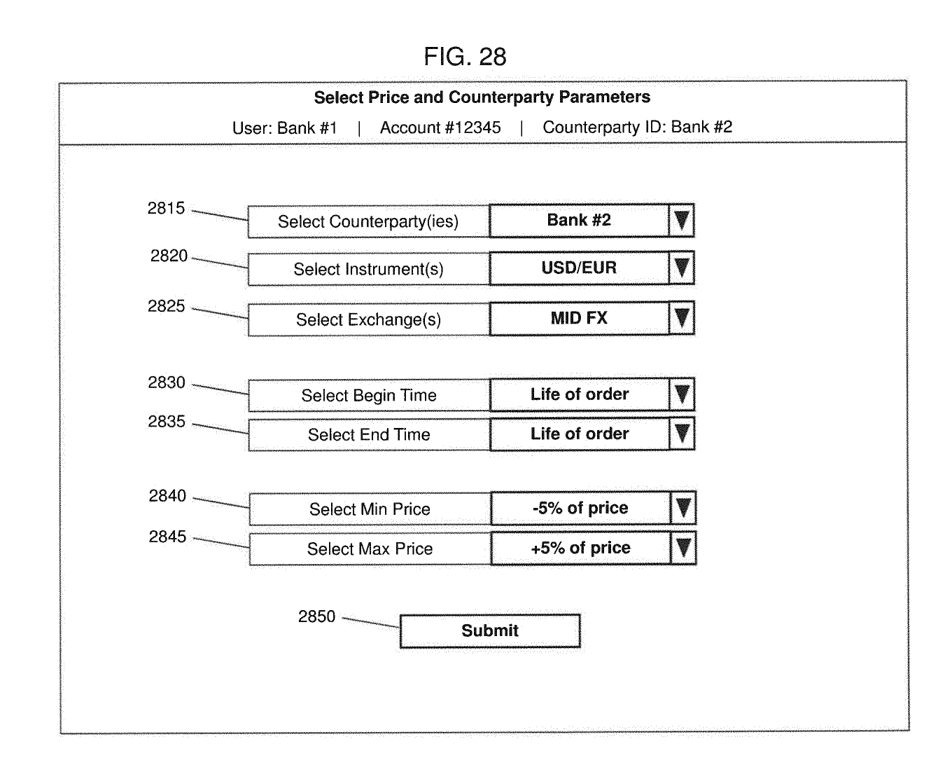

FIG. 28 depicts an exemplary interface for configuring price and counterparty parameters according to at least one embodiment of the invention. The system may display the interface to a user, e.g., at a user computer, e.g., via a secure website. In some embodiments, the interface of FIG. 28 may enable a user to specify a minimum and/or maximum price a user is willing to pay (or receive) for a selected product (e.g., currency pair in a foreign exchange) in a trade with a selected other user. The price may be specified in a variety of ways, such as in absolute terms or as a change (e.g., percentage change or deviation amount) from another price, such as a price of the product at the time of submitting an order. Parameters related to the selections may be selected (or input, e.g., via typing) in various areas such as areas 2815-2845.

Area 2815 enables a user (e.g., Bank #1) to a select a counterparty (e.g., Bank #2). In area 2820, a user may select one or more instruments (e.g., products such as a currency pair). In area 2825, a user may select an exchange where the selected parameters are valid (e.g., if a user is participating in multiple different exchanges, the user may specify different min/max prices the user is willing to accept on different exchanges, e.g., different prices for the same party and same product on different exchanges). In areas 2830 and 2835, a user may select a begin time and end time for which the selections may apply. For example, the user may specify that the instructions will apply only for a particular order. For example, in some embodiments, the interface of FIG. 28 may be displayed at the time of entering any new order, such that the user may specify one or more prices from one or more parties the user is willing to accept for the particular order. For example, the user may specify that the parameters should be valid for the life of the order (e.g., until the order expires, or is manually cancelled by the user, etc.). In areas 2840 and 2845, the user may specify a minimum and/or maximum price the user is willing to accept (e.g., in a trade with the selected user for the selected product on the selected exchange during the selected time). The price may be specified in a variety of ways, such as a percentage (or absolute amount) above and below a reference price. The reference price may comprise the current market price (e.g., at the time of submitting an order. In area 2850, the user may press “submit” and cause the system to process the specified parameters. In some embodiments, the interface of FIG. 28 may be the final interface in submitting an order, so the “submit” button may submit the order. In some embodiments, an order interface as described herein may be combined with one or more elements of the interface of FIG. 28.

In some embodiments, the system may enable each user to select, for each of the user's counterparties, which products (e.g., currency pairs in a foreign currency exchange) the user is willing to trade with such counterparty(ies). For example, each user may determine whether or not he will trade in a particular currency pair with a specific user. A user can block trades of one type with one or more users (e.g., trades in a particular currency pair) and specifically enable trades of a specific type with one or more other users.

In some embodiments, the user may enter at a user interface (e.g., similar to the interface of FIG. 26, e.g., at a secure website) an input matrix listing each of the user's counterparties and all tradeable products (e.g., currency pairs) that are potentially tradeable with such counterparty. By making selections in the input matrix (e.g., “allow” or “disallow”), the user can specify which products the user wishes to enable with each counterparty. The interface may automatically deliver instructions regarding the user's inputs to the system for implementation.

In some embodiments, the system may enable each user to set maximum and minimum prices at which the user is willing to trade by product (e.g., currency pair), counterparty, time and other factors. For example, a user may specify that he is willing to pay a maximum of US$2 in exchange for 1 Euro, and/or is willing to receive a minimum of $1.50 in exchange for 1 Euro, e.g., from a particular counterparty (such as Bank #2) for a particular period of time (e.g., from 2-5 pm of a specific trading day). The user may input such minimum and/or maximum prices (e.g., for a currency pair) and any other criteria, such as one or more counterparties and times for which the max and min should be effective, at a user interface such as those described herein. In some embodiments, the minimum and/or maximum prices may apply to a particular order (e.g., an order submitted with the min and/or max inputs), a plurality of orders, a specific time period, good until cancelled, or another time period.

For example, on a secure web site, each user may access an input matrix comprising options to select how to define the price range within which the user will trade. The min and/or max prices and other parameters can be defined by the user in a variety of different ways.

In one embodiment, a user may set for a particular product (e.g., a specific currency pair) a fixed max and/or min price at which the user is willing to trade (e.g., with one or more other users designated by user). The system may enable trades for the user provided that the price is within (or equal to) the specified max and min. In some embodiments, the max and min may comprise a bid-offer pair provided by the user to help configure a market price of a product (as discussed above). In some embodiments, the user may further specify a time (or time range) during which the max and min apply.

In another embodiment, a user may set an amount for one or more products (e.g., currency pairs) that will be added to or subtracted from a price (e.g., a mid-point of various bid-offer pairs determined as described above), such as a market price in effect at the time each order is submitted, in order to determine the max price and min price that is permitted to trade for that user, counterparty, product, time of day, and any other factors (which may be specified by the user at a user interface). For example, if the mid-point price at the time an order is submitted is 1.400005 and the amount set is 0.0005, then the user's max price would be 1.400505 and the user's min price will be 1.390505. In some embodiments, the time for which the user's instructions would apply may be the life of the order, or another time period.

In another embodiment, for one or more products (e.g., currency pairs), a user may specify a percentage of a price (such as the existing mid-point) to be added or subtracted to (or from) a price (such as an existing mid-point at the time each order is submitted) in order to determine the max price and min price at which the user is willing to trade for that product (e.g., for a specific period of time, e.g., until the user's preferences are changed). For example, if the mid-point price at the time an order is submitted is 1.400005 and the percentage set is 0.05%, then the max price will be 1.400705 (the price plus 0.05% of the price) and the min price will be 1.390305 (the price minus 0.05% of the price). The time for which the instructions apply may comprise the life of the order, or another time.

XIX. Alternative Technologies

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

XX. References

The following patents and patent applications are hereby incorporated by reference herein for all purposes: U.S. Pat. No. 6,560,580; and U.S. patent application Ser. No. 09/801,495 filed Mar. 8, 2001, Ser. No. 10/301,527 filed Nov. 21, 2002, Ser. No. 10/699,858 filed Oct. 31, 2003, Ser. No. 11/122,510 filed May 4, 2005, and Ser. No. 12/189,266 filed Aug. 11, 2008. For example, the trading and communication systems and methods disclosed in the above-referenced patents and patent applications may be used to perform trading and communication embodiments of the systems and methods described herein.

What is claimed is:

1-30. (canceled)

31. An apparatus to facilitate electronic trading over an electronic computer network with interfaces of computing devices, the apparatus comprising:
at least one processor of an interface of a computing device; and
a memory that stores instructions which, when executed by the at least one processor of the computing device, direct the at least one processor of the interface of the computing device to:
calculate a first exchange rate for exchanging two currencies comprising a first currency and a second currency, in which to calculate the first exchange rate comprises to:
receive, via an electronic computer network, from a plurality of interfaces of computing devices of users a corresponding plurality of bid-offer pairs, the plurality of users comprising at least an interface of a computing device of a first user, a second user, and a third user, each bid-offer pair comprising:
(1) a bid price for exchanging a first currency for a second currency, and
(2) an offer price for exchanging the second currency for the first currency; and
determine the first exchange rate based on at least two but not all of the received plurality of bid-offer pairs;
receive from the interface of the computing device of the first user a first order to exchange a first volume of the first currency into the second currency;
receive from the interface of the computing device of the second user a second order to exchange a second volume of the second currency into the first currency;
responsive to receiving the first and second orders, cause to be executed a first exchange transaction at the first exchange rate, the first exchange transaction comprising an electronic transfer of a first quantity of the first currency from the interface of the computing device of the first user to the interface of the computing device of the second user and an electronic transfer of a second quantity of the second currency from the interface of the computing device of the second user to the interface of the computing device of the first user;
determine a first market price for exchanging the first currency into the second currency that is in effect at a first predetermined amount of time after the first exchange;
cause to be executed at least one additional exchange transaction between the interfaces of the computing devices of the first user and the second user, each of the at least one additional exchange transaction comprising an exchange of a respective two currencies executed at a respective exchange rate calculated based on a plurality of bid-offer pairs for the respective two currencies received from at least two of the plurality of users;
for each of the at least one additional exchange transaction:
determine a respective market price for exchanging the respective two currencies that is in effect at a respective predetermined amount of time after the respective additional exchange transaction; and
determine a respective difference between the respective market price and the respective exchange rate at which the respective additional exchange transaction was executed;
determine an aggregate flow for a plurality of exchange transactions between the interfaces of the computing devices of the first user and the second user based at least in part on (1) a difference between the first market price and the first exchange rate and (2) each of the respective differences, for each of the at least one additional exchange, between the respective market price and the respective exchange rate at which the respective additional exchange transaction was executed;
after determining the aggregate flow, cause to be executed at least one subsequent exchange transaction between the interfaces of the computing devices of the first user and the second user, each of the at least one subsequent exchange transaction comprising an exchange of a respective two currencies executed at a respective modified exchange rate, the respective modified exchange rate calculated based on (1) a respective rate calculated based on a plurality of bid-offer pairs for the respective two currencies received from at least two of the plurality of users and (2) the aggregate flow;
store in a database transaction information including identities of the users associated with transactions;
communicate with the computing devices to disable the identities of the users from being displayed on the interfaces of the computing devices before execution of the transactions; and
communicate with the computer devices to enable the identities of the users to be displayed on the interfaces of the computing devices after the execution of the transactions.

32. The apparatus of claim 31,
in which the at least one additional exchange transaction between the interfaces of the computing devices of the first user and the second user comprises at least one reverse exchange wherein the first user transfers an amount of the second currency to the second user and the second user transfers an amount of the first currency to the first user,
in which the second order satisfies a minimum time requirement, and
in which the plurality of exchange transactions comprises at least the first exchange and the at least one additional exchange transaction.

33. The apparatus of claim 31, in which the instructions, when executed by the at least one processor, further direct the at least one processor to:
for each of the at least one additional exchange transaction, determine a respective second market price for exchanging the respective two currencies that is in effect at a third predetermined amount of time after the respective additional exchange transaction; and
determine a respective second difference between the respective second market price and the exchange rate at which the respective additional exchange transaction was executed;
in which the act of determining an aggregate flow comprises determining an aggregate flow based at least in part on each of the respective second differences, for each of the at least one additional exchange transaction, between the respective second market price and the exchange rate at which the respective additional exchange transaction was executed.

34. The apparatus of claim 31, in which the instructions, when executed by the at least one processor, further direct the at least one processor to:
cause to be executed a plurality of currency exchange transactions between the interfaces of the computing devices of the first user and the third user, each of the plurality of currency exchange transactions being executed at respective exchange rates calculated based on a plurality of bid-offer pairs for the respective currencies received from at least two of the plurality of users;
for each of the plurality of exchange transactions:
determine a respective market price for exchanging the respective currencies that is in effect at a respective predetermined amount of time after the respective exchange; and
determine a respective difference between the respective market price and the exchange rate at which the respective additional exchange transaction was executed;
determine a second aggregate flow for a plurality of exchange transactions occurring during the specified time period between the interfaces of the computing devices of the first user and the third user based at least in part on the respective differences, for each of the plurality of exchanges, between the respective market price and the respective exchange rates at which the respective exchange transaction was executed; and
after determining the second aggregate flow, cause to be executed at least one later exchange between the interfaces of the computing devices of the first user and the third user, each of the at least one later exchange comprising an exchange of two currencies executed at a respective changed exchange rate, the respective changed exchange rate calculated based on (1) a respective rate for the respective exchange calculated based on a plurality of bid-offer pairs for the respective two currencies received from at least two of the plurality of users and (2) the second aggregate flow.

35. The apparatus of claim 31,
in which the first predetermined amount of time is equal to each respective second predetermined amount of time for each of the at least one additional exchange transaction; and
in which the at least one additional exchange transaction between the first user and the second user comprises at least one exchange of the first currency for a third currency.

36. The apparatus of claim 31, in which, for each of the at least one subsequent exchange transaction, the respective modified exchange rate is calculated by adding (i) a respective adjustment amount determined based on the aggregate flow to (ii) the respective rate calculated based on a plurality of bid-offer pairs for the two currencies received from at least two of the plurality of users, in which each respective adjustment amount comprises at least one of a positive amount and a negative amount.

37. The apparatus of claim 31, in which the instructions, when executed by the at least one processor, further direct the at least one processor to:
responsive to causing to be executed the first exchange transaction:
cause to be disclosed to the interface of the computing device of the first user that the second user was a counterparty to the first exchange transaction, and
cause to be disclosed to the interface of the computing device of the second user that the first user was a counterparty to the first exchange transaction,
wherein information identifying the first user in connection with the first order was not disclosed to the second user before the first exchange transaction, and wherein information identifying the second user in connection with the second order was not disclosed to the first user before the first exchange transaction.

38. The apparatus of claim 31,
in which the first order satisfies a minimum time requirement,
in which the at least one additional exchange transaction between the interface of the computing device of the first user and the second user comprises at least one exchange of a third currency for a fourth currency, and
in which the at least one additional exchange transaction between the interface of the computing device of the first user and the second user comprises at least one exchange of the first currency for a third currency.

39. The apparatus of claim 31,
in which the determined aggregate flow for the plurality of exchange transactions between the interfaces of the computing devices of the first user and the second user indicates that the plurality of exchange transactions, considered in aggregate, benefitted the first user to the detriment of the second user; and
in which the act of causing to be executed at least one subsequent exchange transaction between the interfaces of the computing devices of the first user and the second user at a respective modified exchange rate comprises: causing to be executed at least one subsequent exchange transaction between the interfaces of the computing devices of the first user and the second user at a respective rate that is adjusted to benefit the second user and to disadvantage the first user.

40. The apparatus of claim 39, in which the act of causing to be executed at least one subsequent exchange transaction between the interfaces of the computing devices of the first user and the second user at a respective modified exchange rate comprises: causing to be executed at least one subsequent exchange transaction between the first user and the second user at the respective modified exchange rate, in which each of the respective modified exchange rate is calculated by adjusting (1) the respective rate calculated based on a plurality of bid-offer pairs for the two currencies received from at least two of the plurality of users by (2) a respective adjustment amount determined based on the aggregate flow.

41. The apparatus of claim 40,
in which for each of the at least one subsequent exchange transaction, the respective adjust amount is determined such that a flow of the at least one subsequent exchange transaction will be opposite to the aggregate flow, and
in which the bid price and the offer price of the bid-offer pair are both expressed in units of the first currency.

42. The apparatus of claim 31, in which the instructions, when executed by the at least one processor, further direct the at least one processor to:
after determining the aggregate flow and before causing to be executed at least one subsequent exchange transaction between the interfaces of the computing devices of the first user and the second user, cause one or more reports to be provided to the first user indicating information about the aggregate flow.

43. The apparatus of claim 31, in which the instructions, when executed by the at least one processor, further direct the at least one processor to:
before causing to be executed the first exchange transaction:
(1) determine that the bid price and the offer price of each bid-offer pair in the set of overlapping bid-offer pairs is unexpired during the time of interest;
(2) determine whether any of the bid-offer pairs comprises a bid price that is higher than the offer price of the bid-offer pair;
(3) for each bid-offer pair, determine that the bid-offer pair comprises a quote spread that is less than a predetermined threshold;
(4) determine from the plurality of bid-offer pairs a set of qualifying bid-offer pairs, the set of qualifying bid-offer pairs comprising each bid-offer pair of the plurality of bid-offer pairs that satisfies each of the following conditions:
(a) the bid price of the bid-offer pair and the offer price of the bid-offer pair are both unexpired at the time of interest;
(b) the bid price of the bid-offer pair is lower than the offer price of the bid-offer pair; and
(c) the bid-offer pair comprises a quote spread that is less than a predetermined threshold; and
(5) determine from the set of qualifying bid-offer pairs a set of overlapping bid-offer pairs, in which each overlapping bid-offer pair comprises a range such that (i) the number of bid-offer pairs having a range that overlaps the range of the bid-offer pair is at least half of (ii) the number of eligible bid-offer pairs minus one, in which two ranges overlap if they both include at least one price in common,
in which the act of determining the first exchange rate based on at least two but not all of the received plurality of bid-offer pairs comprising determining the first exchange rate based on the determined set of overlapping bid-offer pairs.

44. A method to facilitate electronic trading over an electronic computer network with interfaces of computing devices, the method comprising:
calculating, by at least one processor of an interface of a computing device of an electronic computer network in electronic communication with other interfaces of computing devices, a first exchange rate for exchanging two currencies comprising a first currency and a second currency, in which the act of calculating the first exchange rate comprises:
receiving, by the at least one processor via an electronic computer network, from a plurality of interfaces of computing devices of users a respective plurality of bid-offer pairs, the plurality of users comprising at least a first user, a second user, and a third user, each bid-offer pair comprising:
(1) a bid price for exchanging a first currency for a second currency, and
(2) an offer price for exchanging the second currency for the first currency; and
determining, by the at least one processor of the interface of the computing device, the first exchange rate based on at least two but not all of the received plurality of bid-offer pairs;
receiving, by the at least one processor of the interface of the computing device, from the interface of the computing device of the first user a first order to exchange a first volume of the first currency into the second currency;
receiving, by the at least one processor of the interface of the computing device, from the interface of the computing device of the second user a second order to exchange a second volume of the second currency into the first currency;
responsive to receiving the first and second orders, causing to be executed, by the at least one processor, a first exchange transaction at the first exchange rate, the first exchange transaction comprising a transfer of a first quantity of the first currency from the first user to the second user and a transfer of a second quantity of the second currency from the second user to the first user;
determining, by the at least one processor of the interface of the computing device, a first market price for exchanging the first currency into the second currency that is in effect at a first predetermined amount of time after the first exchange;
causing to be executed, by the at least one processor of the interface of the computing device, at least one additional exchange transaction between the interfaces of the computing devices of the first user and the second user, each of the at least one additional exchange transaction comprising an exchange of two currencies executed at a respective exchange rate calculated based on a plurality of bid-offer pairs for the two currencies received from at least two of the plurality of users;
for each of the at least one additional exchange transaction:
determining, by the at least one processor, a respective market price for exchanging the respective two currencies that is in effect at a respective predetermined amount of time after the respective additional exchange transaction;
determining, by the at least one processor, a respective difference between the respective market price and the exchange rate at which the respective additional exchange transaction was executed;
determining, by the at least one processor of the interface of the computing device, an aggregate flow for a plurality of exchange transactions between the first user and the second user based at least in part on (1) a difference between the first market price and the first exchange rate and (2) each of the respective differences, for each of the at least one additional exchange, between the respective market price and the exchange rate at which the respective additional exchange transaction was executed;
after determining the aggregate flow, causing to be executed, by the at least one processor, at least one subsequent exchange transaction between the interface of the computing device of the first user and the second user, each of the at least one subsequent exchange transaction comprising an exchange of two currencies executed at a respective modified exchange rate, the respective modified exchange rate calculated based on (1) a respective rate calculated based on a plurality of bid-offer pairs for the two currencies received from at least two of the plurality of users and (2) the aggregate flow; and
storing in a database transaction information including identities of the users associated with transactions;
communicating with the computing devices to disable the identities of the users from being displayed on the interfaces of the computing devices before execution of the transactions; and
communicating with the computer devices to enable the identities of the users to be displayed on the interfaces of the computing devices after the execution of the transactions.

45. The method of claim 44 further comprising:
causing to be executed a plurality of currency exchange transactions between the interfaces of the computing devices of the first user and the third user, each of the plurality of currency exchange transactions being executed at respective exchange rates calculated based on a plurality of bid-offer pairs for the respective currencies received from at least two of the plurality of users;
for each of the plurality of exchange transactions:
determining a respective market price for exchanging the respective currencies that is in effect at a respective predetermined amount of time after the respective exchange; and
determining a respective difference between the respective market price and the exchange rate at which the respective additional exchange transaction was executed;
determining a second aggregate flow for a plurality of exchange transactions occurring during the specified time period between the first user and the third user based at least in part on the respective differences, for each of the plurality of exchanges, between the respective market price and the respective exchange rates at which the respective exchange was executed; and
after determining the second aggregate flow, causing to be executed at least one later exchange between the interfaces of the computing devices of the first user and the third user, each of the at least one later exchange comprising an exchange of two currencies executed at a respective changed exchange rate, the respective changed exchange rate calculated based on (1) a respective rate for the respective exchange calculated based on a plurality of bid-offer pairs for the respective two currencies received from at least two of the plurality of users and (2) the second aggregate flow,
in which the plurality of exchange transactions comprises at least the first exchange and the at least one additional exchange transaction.

46. An apparatus to facilitate electronic trading over an electronic computer network with interfaces of computing devices, the apparatus comprising:
at least one processor; and
a memory that stores instructions which, when executed by the at least one processor, direct the at least one processor to:
receive, via an electronic computer network, from a plurality of interfaces of computing devices of users a corresponding plurality of bid-offer pairs for a financial instrument, the plurality of users comprising at least a first user, a second user, and a third user, each bid-offer pair comprising:
(1) a bid price for purchasing the financial instrument, and
(2) an offer price for selling the financial instrument;
calculate a first price based on at least two but not all of the received plurality of bid-offer pairs;
receive from the interface of the computing device of the first user a first order to buy or sell a first quantity of the financial instrument;
receive from the interface of the computing device of the second user a second order to buy or sell a second quantity of the financial instrument, the second order being contra to the first order;
responsive to receiving the first and second orders, cause to be executed at the first price a first trade between interfaces of the computing devices of the the first user and the second user for at least a portion of the first quantity and at least a portion of the second quantity of the financial instrument;
determine a first market price for the financial instrument that is in effect at a first predetermined amount of time after the first trade;
cause to be executed at least one additional trade between the interfaces of the computing devices of the first user and the second user, each of the at least one additional trade comprising a purchase or sale of a respective trading product at a respective price calculated based on a plurality of bid-offer pairs for the respective trading product received from at least two of the plurality of users;
for each of the at least one additional trade:
determine a respective market price for the respective trading product that is in effect at a respective predetermined amount of time after the respective additional exchange transaction; and
determine a respective difference between the respective market price and the respective price of the respective at least one additional trade;
determine an aggregate flow for a plurality of transactions between the interfaces of the computing devices of the first user and the second user based at least in part on (1) a difference between the first market price and the first price and (2) each of the respective differences, for each of the at least one additional trade, between the respective market price and the price at which the respective additional trade was executed; and
after determining the aggregate flow, cause to be executed at least one subsequent trade between the interfaces of the computing devices of the first user and the second user, each of the at least one subsequent trade comprising a purchase or sale of a respective trading product at a respective modified price, the respective modified price calculated based on (1) a respective price calculated based on a plurality of bid-offer pairs for the respective trading product received from at least two of the plurality of users and (2) the aggregate flow; and.
store in a database transaction information including identities of the users associated with transactions;
communicate with the computing devices to disable the identities of the users from being displayed on the interfaces of the computing devices before execution of the transactions; and
communicate with the computer devices to enable the identities of the users to be displayed on the interfaces of the computing devices after the execution of the transactions.

47. The apparatus of claim 46, in which the instructions, when executed by the at least one processor, further direct the at least one processor to:
for each of the at least one additional trade, determine a respective second market price for the financial instrument that is in effect at a respective third predetermined amount of time after the respective additional trade; and
determine a respective second difference between the respective second market price and the respective price at which the respective additional trade was executed;
in which the act of determining an aggregate flow comprises determining an aggregate flow based at least in part on each of the respective second differences, for each of the at least one additional transaction, between the respective second market price and the respective price at which the respective additional transaction was executed; and
in which the plurality of transactions comprises at least the first trade and the at least one additional trade.

48. The apparatus of claim 46, in which the instructions, when executed by the at least one processor, further direct the at least one processor to:
cause to be executed a plurality of transactions between the interfaces of the computing devices of the first user and the third user, each of the plurality of transactions being a purchase of a respective trading product executed at a respective price calculated based on a plurality of bid-offer pairs for the respective trading product received from at least two of the plurality of users;
for each of the plurality of transactions:
determine a respective market price for the respective trading product that is in effect at a respective time duration after the respective transaction;
determine a respective difference between the respective market price and the price at which the respective additional transaction was executed;
determine a second aggregate flow for a plurality of trades occurring during a specified time period between the first user and the third user based at least in part on the respective differences, for each of the plurality of trades, between the respective market price and the respective price at which the respective trade was executed; and
after determining the second aggregate flow, cause to be executed at least one later transaction between the first user and the third user, each of the at least one later transaction comprising a respective purchase of a respective trading product at a respective changed price, the respective changed price calculated based on (1) a respective price for the respective purchase calculated based on a plurality of bid-offer pairs for the respective trading product received from at least two of the plurality of users and (2) the second aggregate flow.

49. The apparatus of claim 46,
in which the first predetermined amount of time is equal to each of the respective predetermined amount of time for each of the at least one additional trade;
in which the at least one additional transaction between the interfaces of the computing devices of the first user and the second user comprises a purchase of a trading product different from the financial instrument;
in which the first order satisfies a minimum time requirement; and
in which the financial instrument and the trading product are the same.

50. The apparatus of claim 46, in which, for each of the at least one subsequent transaction, the respective modified rate is calculated by adding (i) a respective adjustment amount determined based on the aggregate flow to (ii) the respective rate calculated based on a plurality of bid-offer pairs for the two currencies received from at least two of the plurality of users, in which each adjustment amount comprises at least one of a positive amount and a negative amount.

51. The apparatus of claim 46, in which the instructions, when executed by the at least one processor, further direct the at least one processor to:
responsive to causing to be executed the first trade:
cause to be disclosed to the interface of the computing device of the first user that the second user was a counterparty to the first trade, and
cause to be disclosed to the interface of the computing device of the second user that the first user was a counterparty to the first trade,
wherein information identifying the first user in connection with the first order was not disclosed to the second user before the first trade, and
wherein information identifying the second user in connection with the second order was not disclosed to the first user before the first trade.

52. The apparatus of claim 46,
in which the first order satisfies a minimum time requirement,
in which the at least one additional transaction between the interfaces of the computing devices of the first user and the second user comprises at least one purchase of a trading product different from the financial instrument.

53. The apparatus of claim 46,
in which the determined aggregate flow for the plurality of transactions between the interfaces of the computing devices of the first user and the second user indicates that the plurality of transactions, considered in aggregate, advantaged the first user and disadvantaged the second user; and
in which the act of causing to be executed at least one subsequent transaction between the first user and the second user at a respective modified price comprises: causing to be executed at least one subsequent transaction between the first user and the second user at a respective rate that is adjusted to advantage the second user and to disadvantage the first user.

54. The apparatus of claim 53, in which the act of causing to be executed at least one subsequent transaction between the interfaces of the computing devices of the first user and the second user at a respective modified rate comprises:
causing to be executed at least one subsequent transaction between the interfaces of the computing devices of the first user and the second user at the respective modified price, in which each respective modified price is calculated by adjusting (1) the respective price calculated based on a plurality of bid-offer pairs for the respective trading product received from at least two of the plurality of users by (2) a respective adjustment amount determined based on the aggregate flow.

55. The apparatus of claim 54,
in which, for each of the at least one subsequent transaction, the respective adjust amount is determined such that a flow of the at least one subsequent transaction will be opposite to the aggregate flow.

56. The apparatus of claim 46, in which the instructions, when executed by the at least one processor, further direct the at least one processor to:
after determining the aggregate flow and before causing to be executed at least one subsequent trade between the interfaces of the computing devices of the first user and the second user, cause one or more reports to be provided to the first user and the second user indicating information about the aggregate flow.

57. The apparatus of claim 46, in which the instructions, when executed by the at least one processor, further direct the at least one processor to:
(1) determine that the bid price and the offer price of each bid-offer pair in the set of overlapping bid-offer pairs is unexpired during the time of interest;
(2) determine whether any of the bid-offer pairs comprises a bid price that is higher than the offer price of the bid-offer pair;
(3) for each bid-offer pair, determine that the bid-offer pair comprises a quote spread that is less than a predetermined threshold;
(4) determine from the plurality of bid-offer pairs a set of qualifying bid-offer pairs, the set of qualifying bid-offer pairs comprising each bid-offer pair of the plurality of bid-offer pairs that satisfies each of the following conditions:
(a) the bid price of the bid-offer pair and the offer price of the bid-offer pair are both unexpired at the time of interest;
(b) the bid price of the bid-offer pair is lower than the offer price of the bid-offer pair; and
(c) the bid-offer pair comprises a quote spread that is less than a predetermined threshold; and
(5) determine from the set of qualifying bid-offer pairs a set of overlapping bid-offer pairs, in which each overlapping bid-offer pair comprises a range such that (i) the number of bid-offer pairs having a range that overlaps the range of the bid-offer pair is at least half of (ii) the number of eligible bid-offer pairs minus one, in which two ranges overlap if they both include at least one price in common,
in which the act of determining the first price based on at least two but not all of the received plurality of bid-offer pairs comprising determining the first price based on a set of overlapping bid-offer pairs.

58. An apparatus, comprising:
at least one processor; and
a memory that stores instructions which, when executed by the at least one processor, direct the at least one processor to:
receive from a plurality of users, via an electronic computer network, a respective plurality of bid-offer pairs for a first financial instrument, the plurality of users comprising at least a first user, a second user, and a third user, each bid-offer pair comprising:
(1) a bid price for purchasing the financial instrument, and
(2) an offer price for selling the financial instrument;
calculate a first price for a first financial instrument based on at least two but not all of the received plurality of bid-offer pairs;
receive from the first user a first order to buy a first volume of the first financial instrument;
receive from the second user a second order to sell a second volume of the first financial instrument;
responsive to receiving the first and second orders, cause to be executed a first transaction between the first user and the second user at the first price, the first transaction comprising a purchase by the first user of a first quantity of the financial instrument from the second user;
responsive to causing to be executed the first transaction:
cause to be disclosed to the first user that the second user was a counterparty to the first transaction, and
cause to be disclosed to the second user that the first user was a counterparty to the first transaction,
wherein information identifying the first user in connection with the first order was not disclosed to the second user before the first transaction, and wherein information identifying the second user in connection with the second order was not disclosed to the first user before the first transaction;
determine a first market price for the first financial instrument that is in effect at a first predetermined amount of time after the first transaction;
determine a first difference between the first market price and the first price;
after receiving the plurality of bid-offer pairs, receive a plurality of new bid-offer pairs for a trading product from the plurality of users;
determine a second price for the trading product based on the plurality of new bid-offer pairs;
receive a third order to purchase a third volume of the trading product;
receive a fourth order to sell a fourth volume of the trading product;
responsive to receiving the third and fourth orders, cause to be executed a second transaction at the second price, the second transaction comprising a trade of the trading product between the third user and another of the plurality of users;
cause to be executed at least one additional transaction between the first user and the second user, each of the at least one additional transaction comprising a purchase of a respective product at a respective price calculated based on some but not all of a respective second plurality of bid-offer pairs for the respective product received from the plurality of users;
for each of the at least one additional transaction:
determine a respective market price for the respective product that is in effect at a respective predetermined amount of time after the respective additional transaction; and
determine a respective difference between the respective market price and the respective price at which the respective additional transaction was executed;
determine an aggregate flow for a plurality of past transactions between the first user and the second user based at least in part on (1) the first difference between the first market price and the first price and (2) each of the respective differences, for each of the at least one additional transaction, between the respective market price and the respective price at which the respective additional transaction was executed;
after determining the aggregate flow, cause to be executed at least one subsequent transaction between the first user and the second user, each of the at least one subsequent transaction comprising a purchase of respective trading product at a respective modified price, the respective modified price calculated based on (1) a respective price calculated based on a plurality of bid-offer pairs for the respective trading product received from at least two of the plurality of users and (2) the aggregate flow;
store in a database transaction information including identities of the users associated with transactions;
communicate with with computing devices to disable the identities of the users from being displayed on interfaces of the computing devices before execution of the transactions; and
communicate with the computer devices to enable the identities of the users to be displayed on the interfaces of the computing devices after the execution of the transactions.

59. The apparatus of claim 58, in which the instructions, when executed by the at least one processor, further direct the at least one processor to:
before causing to be executed the first transaction:
(1) determine that the bid price and the offer price of each bid-offer pair in the set of overlapping bid-offer pairs is unexpired during the time of interest;
(2) determine whether any of the bid-offer pairs comprises a bid price that is higher than the offer price of the bid-offer pair;
(3) for each bid-offer pair, determine that the bid-offer pair comprises a quote spread that is less than a predetermined threshold;
(4) determine from the plurality of bid-offer pairs a set of qualifying bid-offer pairs, the set of qualifying bid-offer pairs comprising each bid-offer pair of the plurality of bid-offer pairs that satisfies each of the following conditions:
(a) the bid price of the bid-offer pair and the offer price of the bid-offer pair are both unexpired at the time of interest;
(b) the bid price of the bid-offer pair is lower than the offer price of the bid-offer pair; and
(c) the bid-offer pair comprises a quote spread that is less than a predetermined threshold; and
(5) determine from the set of qualifying bid-offer pairs a set of overlapping bid-offer pairs, in which each overlapping bid-offer pair comprises a range such that (i) the number of bid-offer pairs having a range that overlaps the range of the bid-offer pair is at least half of (ii) the number of eligible bid-offer pairs minus one, in which two ranges overlap if they both include at least one price in common,
in which the act of determining the first price based on at least two but not all of the received plurality of bid-offer pairs comprising determining the first price based on the determined set of overlapping bid-offer pairs,
in which the trading product is the same as the financial instrument, and
in which the plurality of past transactions comprises at least the first transaction and the at least one additional transaction.

60. The apparatus of claim 58, in which the instructions, when executed by the at least one processor, further direct the at least one processor to:
for each of the at least one additional transaction, determine a respective second market price for the financial instrument that is in effect at a respective third predetermined amount of time after the respective additional transaction; and
determine a respective second difference between the respective second market price and the respective price at which the respective additional transaction was executed;
in which the act of determining an aggregate flow comprises determining an aggregate flow based at least in part on each of the respective second differences, for each of the at least one additional transaction, between the respective second market price and the respective price at which the respective additional trade was executed;
in which the trading product is different from the financial instrument;
in which the first order satisfies a minimum time requirement; and
in which the first predetermined amount of time is equal to each of the respective predetermined amount of time for each of the at least one additional transaction.
